(19) United States
(12) Patent Application Publication
(10) Pub. No.: US 2014/0237763 A1
(43) Pub. Date: Aug. 28, 2014

(54) Backflush Filter Cleaning System and Method of Use

(71) Applicants: Stuart V. Holsten, Stover, MO (US); David E. Beth, St. Charles, MO (US); Jeffrey L. Young, St. Peters, MO (US); Robert R. Hollis, Saint Peters, MO (US)

(72) Inventors: Stuart V. Holsten, Stover, MO (US); David E. Beth, St. Charles, MO (US); Jeffrey L. Young, St. Peters, MO (US); Robert R. Hollis, Saint Peters, MO (US)

(21) Appl. No.: 14/073,862

(22) Filed: Nov. 6, 2013

Related U.S. Application Data
(60) Provisional application No. 61/723,041, filed on Nov. 6, 2012.
(60) Provisional application No. 61/827,912, filed on May 28, 2013.

(51) Int. Cl. A47L 9/20; B01D 46/00

(52) U.S. Cl. CPC A47L 9/20; B01D 46/0068; B01D 46/0086
USPC 15/352; 55/302; 96/397; 96/417

(57) ABSTRACT

A backflush filter cleaning system for use with a vacuum cleaner employing an internal filter may include a filter cage having a first end, a second end and a peripheral opening, a backflush valve coupled to the first end, an intake plenum coupled to the second end, the plenum having an air outlet, an inlet valve coupled between the peripheral opening and the air outlet, and a cleaning actuator coupled to at least one of the valves. The system can be adapted to clean a filter coupled to a vacuum cleaner where the system can include a means for establishing a first airflow path from inside the collector through the filter, to the vacuum source, a means for flowing air along the first airflow path, and a means for establishing a second airflow path from an atmosphere surrounding the vacuum cleaner through the backflush valve, through the filter, and into the collector to clean the filter.

### CROSS REFERENCE TO RELATED APPLICATIONS

This application claims priority to U.S. Provisional patent application Ser. No. 61/723,041, filed Nov. 6, 2012, and U.S. Provisional patent application Ser. No. 61/827,912, filed May 28, 2013, the contents of all of which are incorporated herein by reference in their entirety.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to cleaning systems for vacuum cleaner filters, and more specifically relate to backflush cleaning systems that clean a filter using ambient air without requiring removal of the filter from the vacuum cleaner.

2. Description of the Related Art

The inventions disclosed and taught herein are directed to an improved backflush filter cleaning system that uses ambient air to clean the filter during vacuuming. Although these inventions can be used in numerous applications, the inventions will be disclosed in only a few of many applications for illustrative purposes.

Typically, when a vacuum cleaner, such as a wet/dry or work area vacuum, is switched “on,” the vacuum motor is energized, which in turn rotates a blower wheel. The rotation of the blower wheel causes a vacuum within the vacuum collection drum. Typically, there is a filter, among other components, interfaced between the blower wheel and the collection drum. When a hose or other such attachment is coupled to the drum, this vacuum will cause air, dirt, liquids, and/or other media or debris to be drawn from a work surface into the drum. As this “dirty” air enters the drum, some of the media particles fall to the bottom of the drum, while other media, typically the finer media particles, may contact the vacuum filter. The filter traps at least some of the particulate media, thus preventing these media from being drawn out of the drum, and exhausted back into the atmosphere of the work area.

It can, therefore, be readily seen that the vacuum filter must from time to time be cleaned or removed and replaced. Typically, to check the filter of a vacuum cleaner, a user must manually remove a lid or some kind of access covering from the vacuum housing in order to gain access to the filter. Thereafter, to clean the filter, one may have to first remove the filter and clean it manually, such as by washing or striking the filter against a hard surface to dislodge accumulated debris particles. However, to remove the filter, one still must generally access it by removing a lid, panel, or other covering. Therefore, for convenience, it can be seen that it would be advantageous to be able to check, clean, and/or remove the filter using a system accessible from the exterior of the vacuum. Further, it can be seen that it would be advantageous to be able to clean the filter using a quick and easy backflush system to reverse airflow through the filter thereby dislodging debris from the filter element.

The inventions disclosed and taught herein are directed to an improved system and method for cleaning one or more filters of a vacuum appliance by backflushing ambient air through the filter assembly without having to first remove the filter from the vacuum.

### BRIEF SUMMARY OF THE INVENTION

A backflush filter cleaning system in accordance with the present disclosure may include a filter cage having a first end, a longitudinally opposite second end, and at least one peripheral opening. The filter cleaning system can further include a backflush valve coupled to the first end, and an intake plenum fluidicly coupled to the second end. The plenum can further include an air inlet and an air outlet, an inlet valve coupled in an air path between the at least one peripheral opening and the air outlet, and a cleaning actuator coupled to at least one of the backflush valve and the inlet valve.

The vacuum cleaner system may include a vacuum source, a collector, a lid coupled to the collector, and at least one backflush filter cleaning system coupled at least partially inside the collector. The system may further include an intake manifold having a first end coupled to the air outlet of the first backflush filter cleaning system and a second end coupled to the vacuum source.

The method of cleaning a filter coupled to a vacuum cleaner can include providing a vacuum source, a collector, a lid coupled to the collector, and at least one filter cleaning system that can include a filter cage having a first end, a longitudinally opposite second end, and at least one peripheral opening. The vacuum cleaner can further include a backflush valve that may be coupled to the first end, an intake plenum that may be coupled to the second end, and a plenum that can include an air inlet and an air outlet. The vacuum cleaner can further include an inlet valve that may further be coupled in an air path between the second end of the filter cage and the air outlet. The vacuum cleaner can further include an intake manifold that can include a first end coupled to the air outlet, a second end coupled to the vacuum source, and a tubular filter coupled between the backflush valve and the inlet valve. The vacuum cleaner can further include a filter that can include a first end in fluid communication with the backflush valve, a second end in fluid communication with the inlet valve, and an inner surface disposed adjacent to the at least one peripheral opening of the filter cage.

The method may include establishing a first airflow path from inside the collector through the filter (e.g., through the inlet valve and to the vacuum source) and energizing the vacuum source, thereby flowing air along the first airflow path. The method may further include closing the inlet valve and opening the backflush valve, thereby establishing a second airflow path from an atmosphere surrounding the vacuum cleaner through the backflush valve, through the filter, and into the collector, and flowing air along the second airflow path, thereby cleaning the filter.

The disclosure also provides a system adapted to clean a filter coupled to a vacuum cleaner, the system can include a means for establishing a first airflow path from inside a vacuum cleaner collector, a means for energizing the vacuum source, a means for closing an inlet valve and opening a backflush valve, thereby establishing a second airflow, and means for flowing air along the second airflow path, thereby cleaning the filter. The means for establishing the first airflow path includes a means for biasing the backflush valve in a closed position and a means for biasing the inlet valve in an open position simultaneously, or otherwise. The means for closing the inlet valve and opening the backflush valve can further be controlled by control logic adapted to be stored on a computer readable medium based on a pressure differential detected by the control logic, or otherwise.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1A illustrates a schematic side view of a first embodiment of an exemplary vacuum cleaner of the present disclosure.

FIG. 1B illustrates a schematic side view of the vacuum cleaner of FIG. 1A, with a partial cut-away showing a first embodiment of an exemplary, typical filter assembly.

FIG. 2 illustrates a schematic side view of a vacuum cleaner of FIG. 1A with the powerhead removed.

FIG. 3 illustrates a schematic top view of the vacuum cleaner of FIG. 1A with the powerhead removed.

FIG. 4A illustrates a schematic isometric view of one of many embodiments of a filter system having two cleaning assemblies and utilizing certain aspects of the present disclosure.

FIG. 4B illustrates a top view of one of many embodiments of a filter system having two cleaning assemblies and utilizing certain aspects of the present disclosure.

FIG. 5 illustrates a schematic cross sectional view through line 4-4 of FIG. 3 illustrating the filter system of FIG. 4A installed in a vacuum cleaner.

FIG. 6A illustrates an enlarged isometric cross-sectional view of a portion of the vacuum cleaner of FIG. 5.

FIG. 6B illustrates an enlarged isometric cross-sectional view of the backflush valve of FIG. 6A.

FIG. 6C illustrates an enlarged schematic cross-sectional view of the inlet valve of FIG. 6A.

FIG. 6D illustrates an isometric view of the inlet valve of FIG. 6C.

FIG. 6E illustrates a perspective view of a first embodiment of an exemplary filter cage in accordance with aspects of the present disclosure.

FIG. 6F illustrates an isometric view of a first embodiment of an exemplary cleaning actuator in accordance with the present disclosure.

FIG. 6G illustrates a bottom isometric view of a first embodiment of an exemplary backflush valve in accordance with aspects of the present disclosure.

FIG. 6H illustrates a top perspective view of a first embodiment of an exemplary inlet valve in accordance with aspects of the present disclosure.

FIG. 7 illustrates a schematic view of one of many embodiments of a vacuum cleaner having a filter system in accordance with certain aspects of the present disclosure.

FIG. 8 illustrates a schematic view of the filter system of FIG. 7 in a cleaning position.

FIG. 9A illustrates a schematic side view of a second embodiment of an exemplary vacuum cleaner of the present disclosure.

FIG. 9B illustrates a schematic side view of a vacuum cleaner of FIG. 9A with the motor cover removed.

FIG. 10 illustrates a schematic top view of the vacuum cleaner of FIG. 9A with the motor cover removed.

FIG. 11A illustrates a schematic cross sectional view through line AA-AA of FIG. 9B illustrating a second embodiment of a filter assembly installed in a vacuum cleaner.

FIG. 11B illustrates a schematic cross sectional view through line AA-AA of the filter system of FIG. 10 installed in a vacuum cleaner with the filters removed.

FIG. 12A illustrates a schematic cross sectional view through line BB-BB of the vacuum cleaner of FIG. 10.

FIG. 12B illustrates an enlarged view of a valve area of the schematic cross sectional view through line BB-BB of the vacuum cleaner of FIG. 12A.

FIG. 12C illustrates an enlarged view of a valve area of the schematic cross sectional view through line BB-BB of the vacuum cleaner of FIG. 12A in Backflush Mode.

FIG. 13A illustrates a top view of a second embodiment of an exemplary vacuum manifold in accordance with aspects of the present disclosure.

FIG. 13B illustrates an enlarged isometric view of the vacuum manifold of FIG. 13A in accordance with aspects of the present disclosure.

FIG. 13C illustrates a bottom view of the vacuum manifold of FIG. 13A in accordance with aspects of the present disclosure.

FIG. 13D illustrates an enlarged isometric view of the vacuum manifold of FIG. 13C in accordance with aspects of the present disclosure.

FIG. 14A illustrates a top isometric view of a spring cap in accordance with aspects of the present disclosure.

FIG. 14B illustrates a bottom isometric view of a spring cap in accordance with aspects of the present disclosure.

FIG. 15 illustrates an isometric view of a second embodiment of a backflush valve in accordance with aspects of the present disclosure.

FIG. 16 illustrates an isometric view of an inlet valve in accordance with aspects of the present disclosure.

FIG. 17 illustrates a cross-sectional view of an alternative embodiment of the present disclosure.

FIG. 18 illustrates the cross-sectional view of FIG. 17, showing air flow pathways within the vacuum system during vacuum operations.

FIG. 19 illustrates the cross-sectional view of FIG. 17, showing air flow pathways within the vacuum system during a cleaning cycle.

FIG. 20 illustrates a cross-sectional view of an exemplary vacuum appliance system in accordance with aspects of the present disclosure.

FIGS. 21A-21B illustrate exemplary valve details in accordance with vacuum systems of the present disclosure.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION OF THE INVENTION

The Figures described above and the written description of specific structures and functions below are not presented to limit the scope of what Applicant has invented or the scope of the appended claims. Rather, the Figures and written description are provided to teach any person skilled in the art to make and use the invention for which patent protection is sought. Those skilled in the art will appreciate that not all features of a commercial embodiment of the invention are described or shown for the sake of clarity and understanding. Persons of skill in this art will also appreciate that the development of an actual commercial embodiment incorporating aspects of the present invention will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location and from time to time. While a developer's efforts might be complex and time-consuming in an absolute sense, such efforts would be, nevertheless, a routine undertaking for those of skill in this art having benefit of this disclosure.

It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally.

Applicants have created a filter system having a backflush filter cleaning mechanism for a vacuum appliance, or vacuum cleaner, such as a wet/dry (i.e., a vacuum capable of picking up both wet and dry debris material) or work place vacuum cleaner, that allows a user to conveniently clean a filter during vacuuming by flowing ambient air through the filter in a direction opposite that of the airflow during normal vacuum operations without having to remove the lid of the vacuum cleaner or the filter. The filter system may include one or more filter cleaning assemblies, a vacuum airflow path from a collector in a first direction through a filter to a vacuum source, and a backflush cleaning air flow path from an atmosphere surrounding the vacuum cleaner in a second direction through the filter to the collector. The filter system may include a valve disposed in each airflow path for switching between the airflow paths during vacuuming.

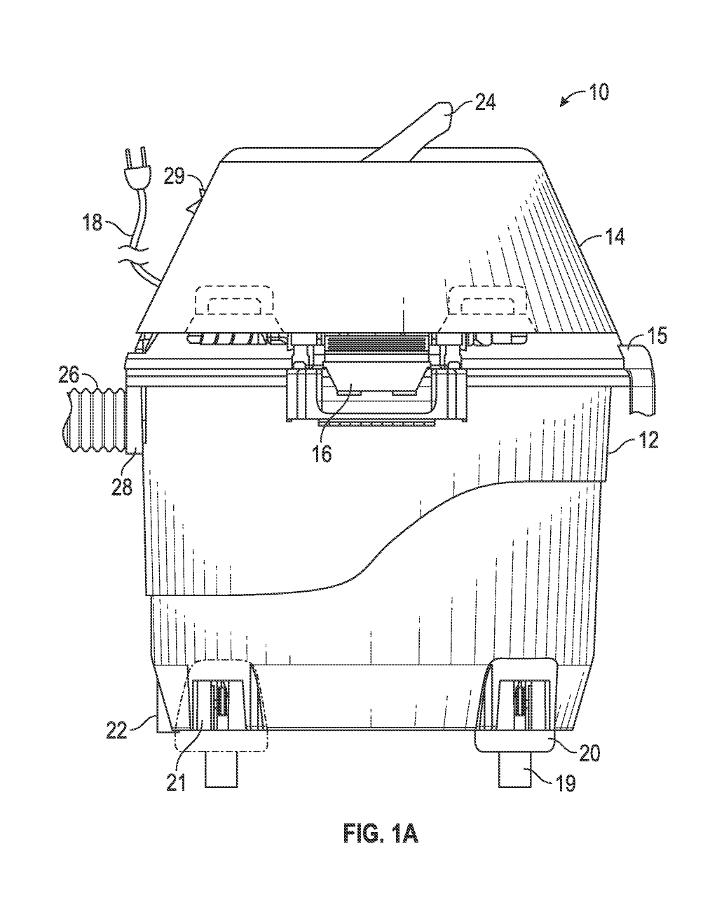

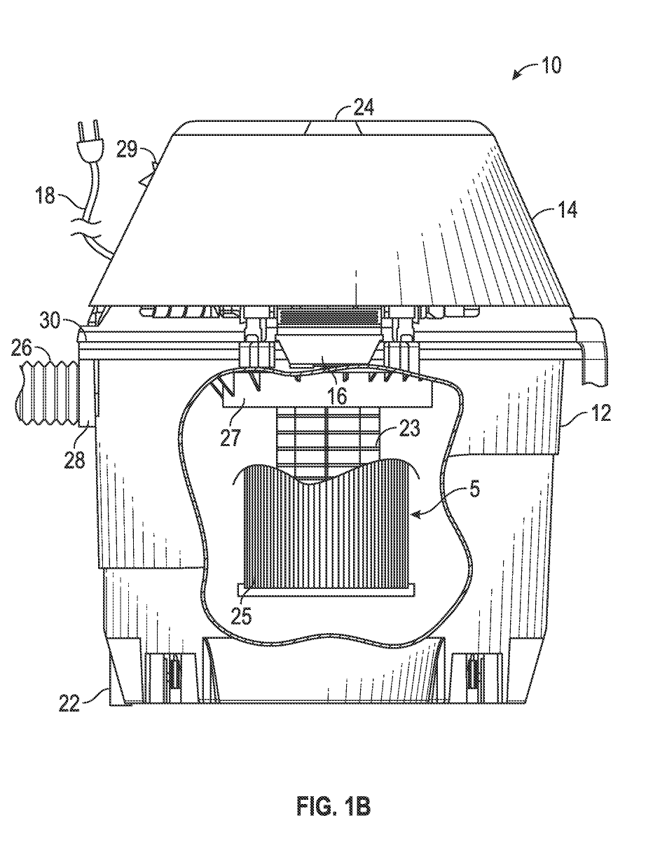

Turning now to the Figures, FIG. 1A is a schematic side view of one of many embodiments of a vacuum cleaner 10 having a filter system 100 and utilizing certain aspects of the present invention, while FIG. 1B is a schematic side view of the vacuum cleaner of FIG. 1A in partial cutaway. FIGS. 1A and 1B will be described in conjunction with each other.

Generally, vacuum 10 may comprise a collection canister, or drum 12 (equivalently referred to herein as a collection drum, vacuum body, body, or collector) having a bottom, sides, and an open top, and having a powerhead 14 releaseably secured via one or more securement latches 16 over the open top of drum 12. Vacuum 10 may be battery powered, or powered via AC or DC electricity, such as via a power cord 18. In accordance with aspects of the instant disclosure, drum 12 may be circular or oval in shape, or may be of another suitable shape as appropriate, such as square or rectangular, without limitation. Vacuum cleaner 10 may, but need not, include a plurality of caster assemblies 20 connected to casters 19 and removably or permanently coupled about the bottom region of collection drum 12 via formed drum mounts 21, wherein the caster assemblies 20 may be removable or permanently fixed as appropriate for the particular vacuum appliance and its intended applications. Furthermore, vacuum 10 can include one or more drum handles 15.

Collection drum 12 may also optionally include a drain plug 22 at the bottom of the drum 12 to aid in the removal of liquid debris from within the drum 12. For example, the drain plug 22 may aid with the ease of draining liquid debris from the drum 12, aid with the ease in cleaning the drum 12 once the powerhead 14 has been removed, or facilitate the attachment of a vacuum pump accessory (not shown). Powerhead 14 typically may have a handle means 24 formed onto or into it, as appropriate, and house a motor and impeller assembly (not shown) for establishing vacuum pressure within the vacuum cleaner 10 when a power actuating switch 29 is engaged. The handle means can include a lever, latch, pivot, or other protuberance or protrusion capable of being grasped by a user's hand.

A flexible vacuum hose 26 may be configured so that one end can be inserted into vacuum inlet 28 formed in, for example, powerhead 14 or the upper region of collection drum 12, and in fluid connection with powerhead 14 within the vacuum itself. In one non-limiting embodiment of the present disclosure, hose 26 is simply friction-fit into vacuum inlet 28. Similarly and equally acceptable, hose 26 may be lock-fitted into vacuum inlet 28, as appropriate.

As illustrated in FIG. 1B, in the partial cut-away of the drum 12 portion of vacuum 10, the vacuum appliance typically also includes one or more suction filter systems S (one is shown) that extend downwardly from the bottom face of the lid 30. The suction filter system S is mounted via a mounting assembly 27 to the bottom face of lid 30, which is in turn removably attached to collection drum 12 for receiving the vacuumed materials.

A portion of the lid 30, herein termed a “mounting assembly” 27, may extend at least partially downward into the drum 12 and mounts a filter support assembly, commonly known as a “filter cage,” 23 that generally covers a vacuum intake (not shown) to the mounting assembly 27 in the lid 30. The cage 23 can be made of plastic such as polypropylene, is generally a cylindrically-shaped molded part having a series of axial and circumferential ribs with a large percentage of open surface area to support the filter 25 extended around the cage. Furthermore, the cage 23 can act to prevent a radially inward collapse of the filter during operation. The axial ribs align with a longitudinal axis through the cage and the circumferential ribs are generally disposed at right angles with respect to the axial ribs. The cage 23 construction creates a relatively stiff component in the axial direction. In addition to supporting filter 25, the cage 23 may provide a safety shield (in some applications) from access to the impeller (not shown), and may contain a float (not shown) that protects the vacuum cleaner 10 from water being inadvertently suctioned into the impeller assembly (not shown). The filter 25 is typically attached to the mounting assembly 27 by a threaded stud (not shown) or other means on the end of cage 23 and places the filter 25 in axial compression, utilizing the longitudinal stiffness of the axial ribs.

For purposes of clarity and understanding, one or more of these components may not be specifically described or shown while, nevertheless, being present in one or more embodiments of the invention, such as in a commercial embodiment, as will be readily understood by one of ordinary skill in the art.

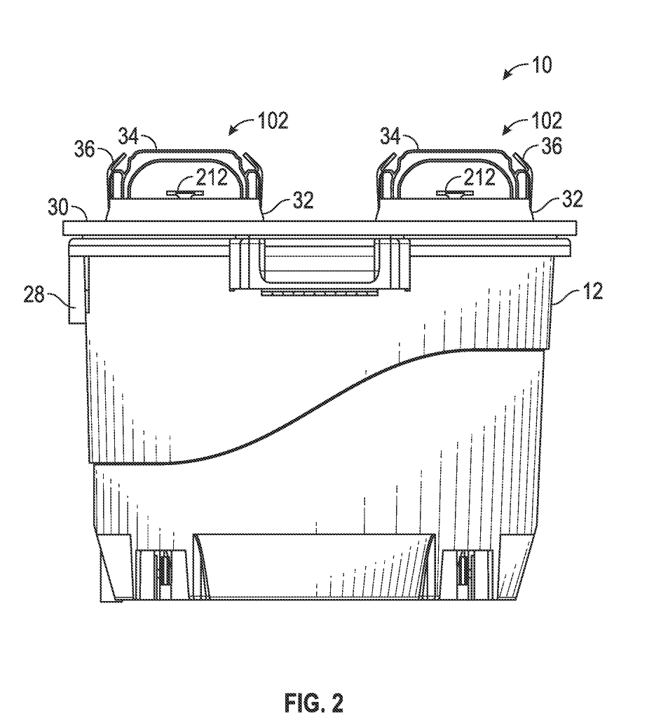

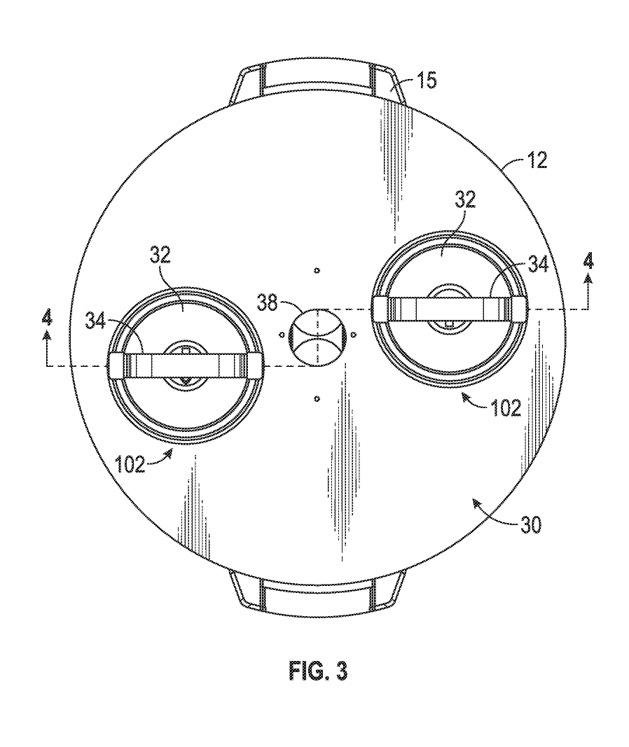

FIG. 2 illustrates a schematic side view of the vacuum cleaner 10 of FIG. 1A with the powerhead 14 removed. FIG. 3 illustrates a schematic top view of the vacuum cleaner 10 of FIG. 2. FIGS. 2 and 3 will be described in conjunction with one another.

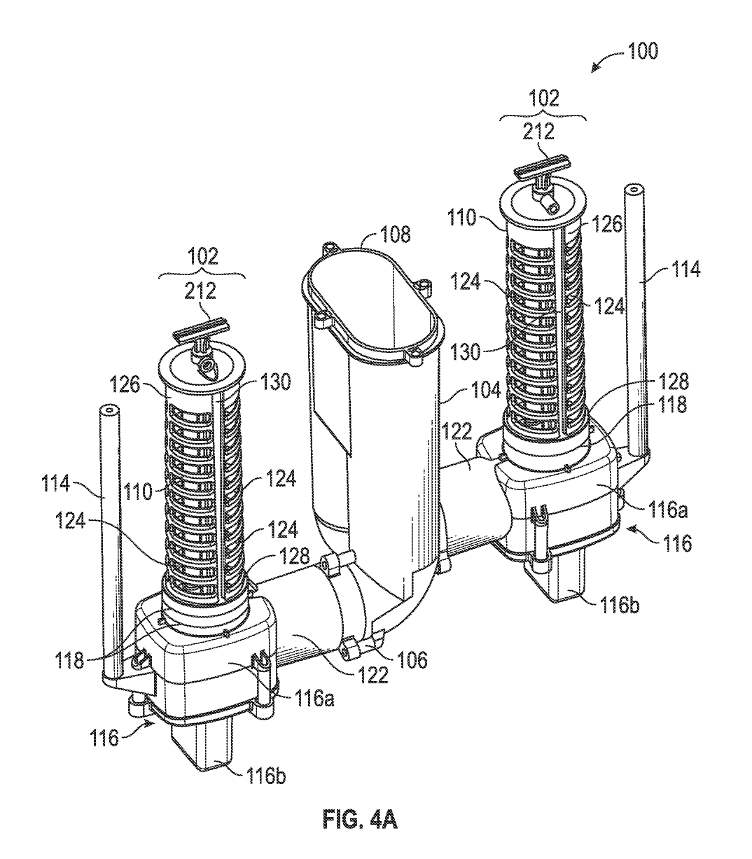

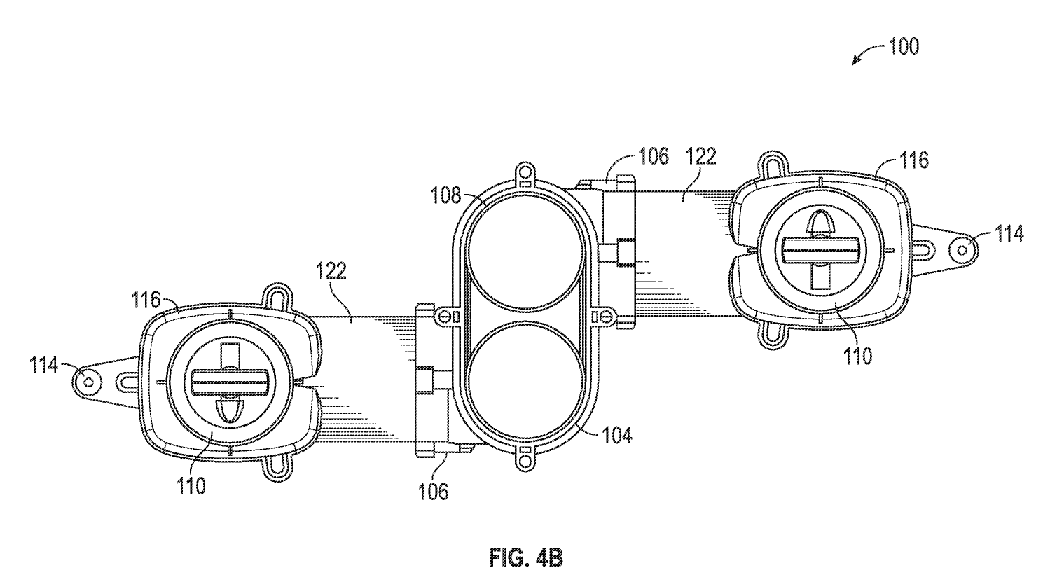

Vacuum cleaner 10 may include a lid 30, which may, but need not, be part of powerhead 14 (FIG. 1A), for sealingly engaging collection drum 12. Vacuum cleaner 10 may include a filter system 100 (as described in greater detail with reference to FIG. 4A), that may include one or more, and preferably two, filter cleaning assemblies 102 having backflush filter cleaning components, which will be described in further detail below. It will be understood that while two cleaning assemblies 102 are shown in FIGS. 2 and 3, vacuum cleaner 10 may have any number of cleaning assemblies 102, such as one, three, or more, as required by a particular application. Furthermore, vacuum 10 can include one or more drum handles 15.

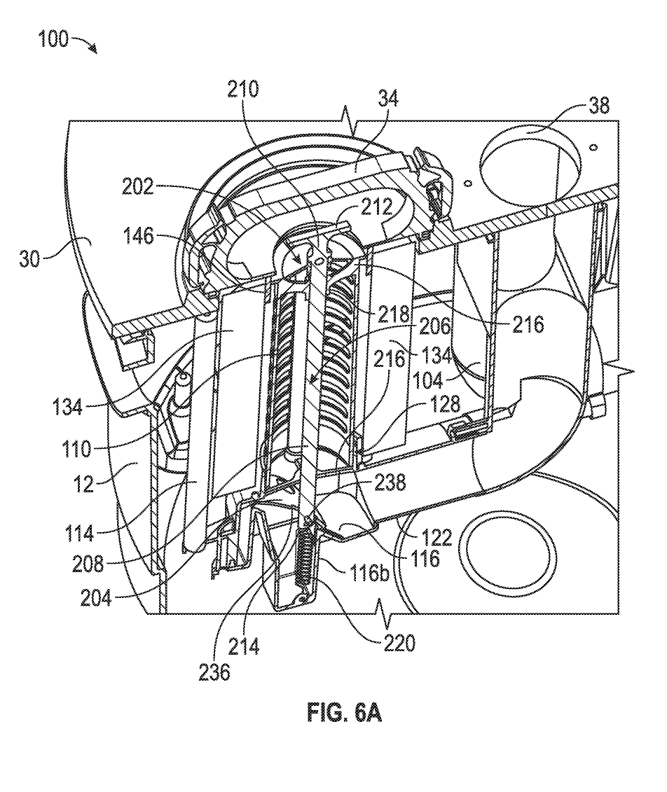

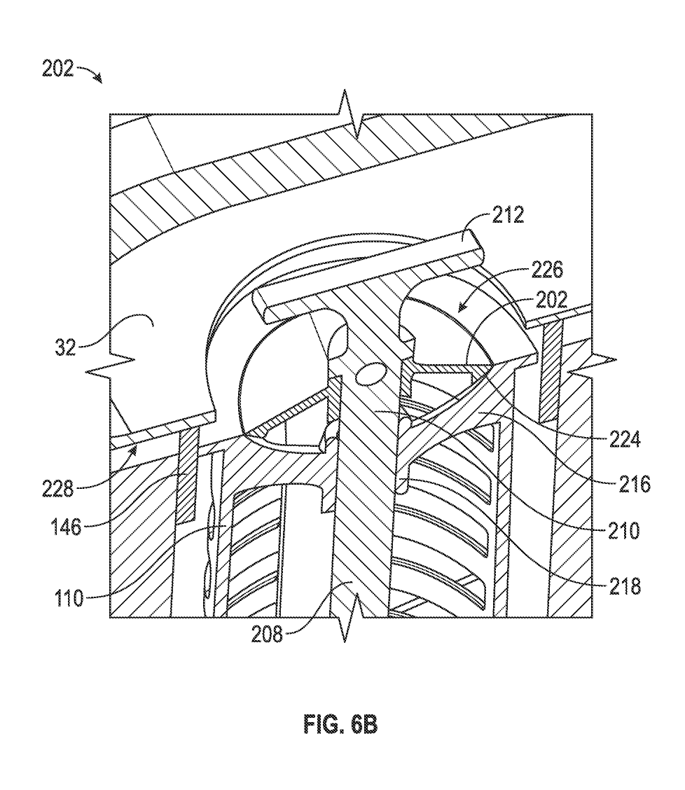

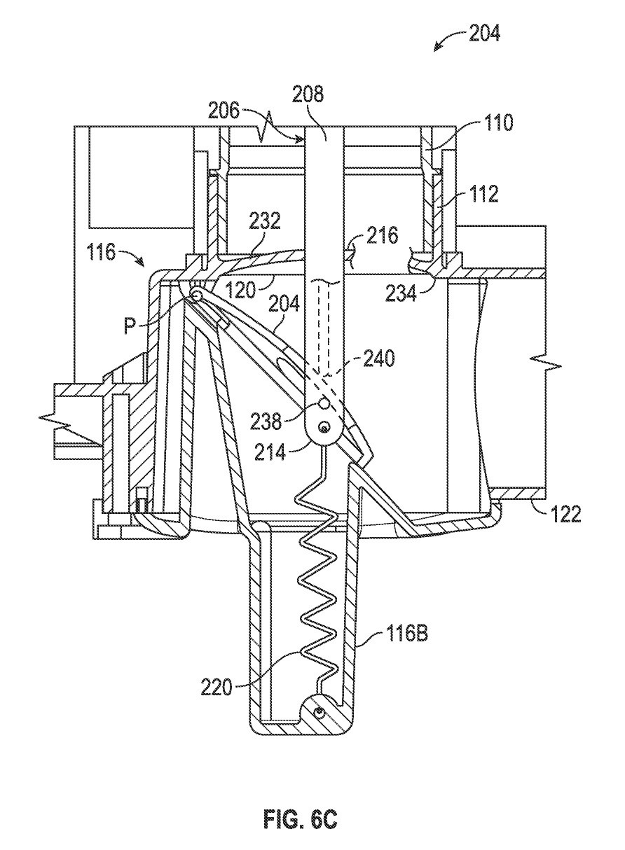

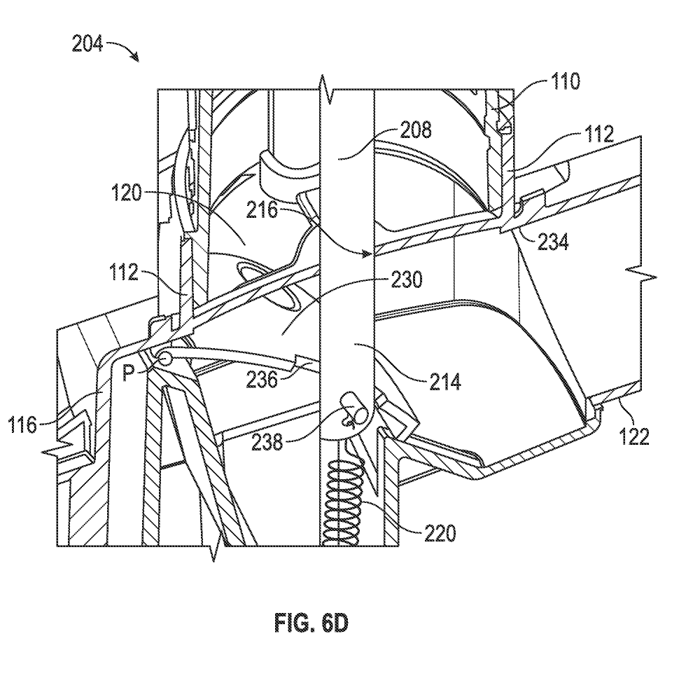

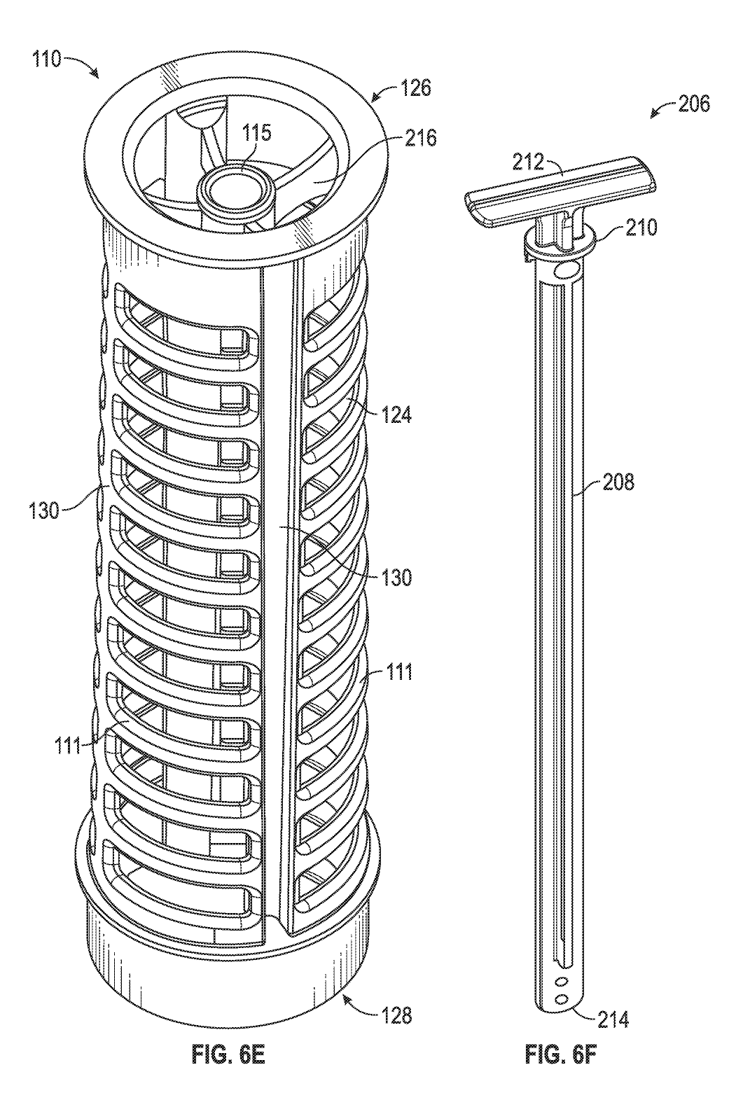

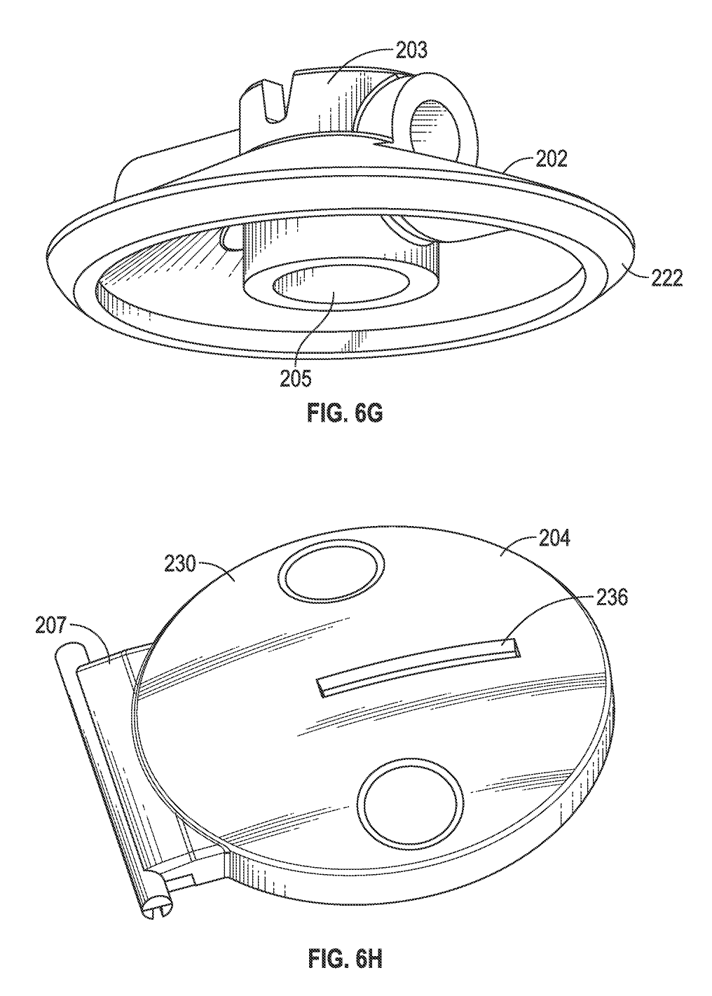

Filter system 100 may be coupled to an opening in lid 30, and may, but need not, include a filter cap 32 (as shown in greater detail in FIG. 3), such as a cap having a handle 34 and one or more latches 36 for sealingly coupling system 100 (FIG. 4A) to lid 30, and one or more latch couples 132. Vacuum cleaner 10 may also include an actuator handle 212 (as described in greater detail below in conjunction with FIGS. 6A and 6B) and a vacuum outlet 38, which may, but need not be, coupled to lid 30, for allowing fluid communication between the powerhead and the interior of drum 12, such as through an intake manifold (e.g., FIG. 4A, element 104) or other conduit.

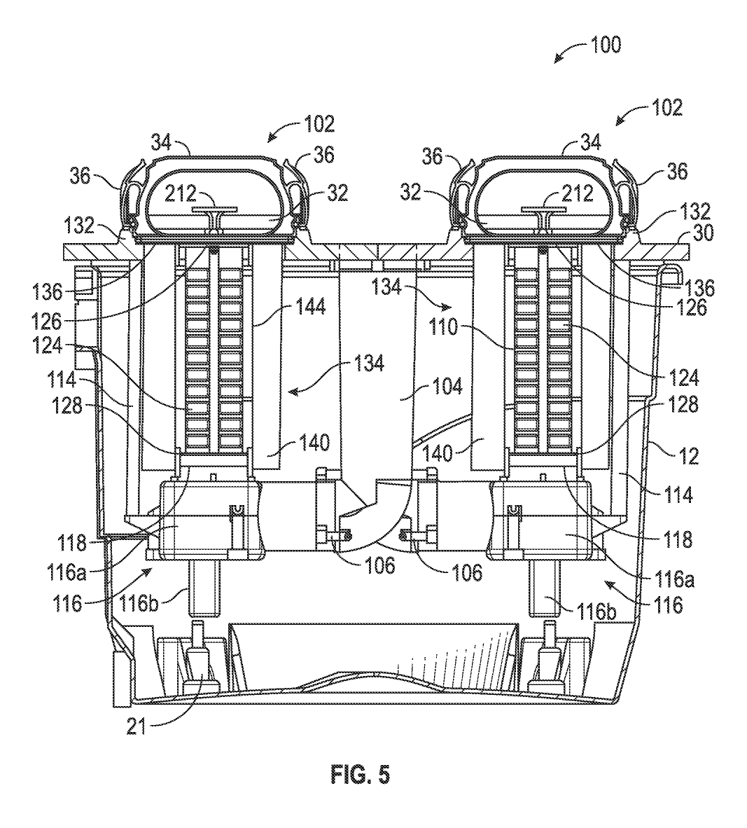

FIG. 4A is a schematic isometric view of one of many embodiments of a filter system 100 having two cleaning assemblies 102 and utilizing certain aspects of the present invention. FIG. 4B is a top view of one of many embodiments of a filter system 100 having two cleaning assemblies 102 and utilizing certain aspects of the present invention. FIG. 5 is a schematic cross sectional view through line 4-4 of FIG. 3 illustrating the filter system 100 of FIG. 4A installed in a vacuum cleaner 10. FIG. 6A is an enlarged isometric cross-sectional view of a portion of the vacuum cleaner 10 of FIG. 5. FIG. 6B is an enlarged isometric cross-sectional view of the backflush valve 202 of FIG. 6A. FIG. 6C is an enlarged schematic cross-sectional view of the inlet valve 204 of FIG. 6A. FIG. 6D is an isometric view of the inlet valve 204 of FIG. 6A. FIG. 6E is an isometric view of a first embodiment of an exemplary filter cage 110 in accordance with the systems of the present disclosure. FIG. 6F illustrates an isometric view of a first embodiment of an exemplary filter cleaning actuator 206 of FIG. 6A. FIG. 6G illustrates a bottom isometric view of backflush valve 202, while FIG. 6H illustrates a top isometric view of an inlet valve 204 in accordance with the systems of the present disclosure. FIGS. 4A-6H will be described in conjunction with one another.

As illustrated, for example, by the embodiment shown in FIG. 4A, which is but one of many, filter system 100 may include structure for supporting and optionally cleaning a filter (see FIG. 5), as will be further described below, such as one or more cleaning assemblies 102 that can each include a backflush valve 202 (as described in greater detail below). Each cleaning assembly 102 may be fluidicly coupled to a first end 106 of an intake manifold 104 for fluid communication with vacuum outlet 38 (FIG. 3) or powerhead 14, such as through second end 108 of the manifold 104. Intake manifold 104 may be a single manifold, such as the one illustrated in FIG. 4A, but need not be and alternatively may include a plurality of manifolds.

Cleaning assembly 102 (shown in FIG. 4A without a filter coupled thereto for point of clarity) may generally include one or more components for holding a filter 25 (FIG. 1B), such as filter cage 110, flange 112, and support 114, coupled to an intake plenum 116, such as for routing air from filter cage 110 to intake manifold 104. Flange 112 may be coupled to filter cage 110, plenum 116, or both, including being formed integrally therewith, in whole or in part, and may be configured to couple to one end of a filter (e.g., FIG. 4B) to support the filter, separately or in combination with other components. Flange 112 may include one or more seals 118, such as for forming a fluidic seal, for example, an at least partially airtight seal, with a filter.

Alternatively, or collectively, the filter may include one or more seals 118, such as a seal that communicates with a surface of flange 112. Each seal 118 may be made from any material, such as plastic, rubber or, as another example, urethane. Support 114 may be any type of support required by a particular application, such as an arm, beam, bracket or other member and may, for example, have one end coupled to plenum 116 and another end coupled to vacuum cleaner 10, such as to lid 30 or drum 12 (as shown in FIG. 1A).

While support 114 is shown to be a tension member in FIG. 4A for illustrative purposes, it need not be, and may alternatively, or collectively, include a compression member, lateral member, or any member for supporting one or more system components, separately or in combination, as will be understood by one of ordinary skill. Plenum 116 may include one or more openings, such as inlet 120 (as shown in FIG. 6C) and outlet 122, in fluid communication with one another. Plenum 116 may be of single piece construction, but need not be, and may alternatively include a plurality of components coupled to one another, such as, for example, a plenum body 116a and a plenum cap 116b. Outlet 122 of plenum 116 may be fluidicly coupled to manifold 104, such as to first end 106, for allowing air to flow there between, as will be further described below.

While inlet 120 (as illustrated in greater detail with reference to 6C) and outlet 122 are illustrated (e.g., FIG. 4A) as being perpendicular to one another, they need not be, and may have any relative orientation required by a particular application, as will be readily understood by one of ordinary skill in the art. Plenum inlet 120 may be fluidicly coupled to filter cage 110, including being formed integrally therewith, in whole or in part. Filter cage 110 may be tubular, and may be configured to support a filter, such as by receiving a filter there around (e.g., FIG. 5).

As illustrated perhaps most clearly in FIG. 6E, filter cage 110 may include one or more openings therein, such as peripheral openings 124, between a first end 126 and a longitudinally opposite second end 128. Filter cage 110 may, but need not, include one or more support members, such as a longitudinal members 130 and horizontal support members 111, coupled between and thereby forming openings 124. Alternatively, filter cage 110 need not include openings 124, and may have an “open” or “slotted” configuration, which may include, for example, having only one or more longitudinal members 130, such as ribs, coupled between first and second ends 126, 128, respectively.

Extending through the center of filter cage 110 is a tubular shaped cavity which guides the placement of, and movement of, cleaning actuator 206 shown in detail in FIG. 6F. Each component of filter system 100, such as filter cage 110 and plenum 116, may be formed in any manner and from any material required by a particular application, in whole or in part. For example, the components may be molded, machined or otherwise formed from plastic, metal, composite, or another material.

While some components may be formed integrally, others may be formed separately and otherwise coupled together, which may include the use of fasteners, such as screws, clips, brackets, adhesives, or other couplers. Further, where components may be sealingly coupled to one another, such as, for example, plenum outlet 122 to first end 106 of manifold 104, seals may be coupled there between. Seals may include gaskets, O-rings, sealants, adhesives, or other seals, whether or not specifically described herein, as will be readily understood by one of ordinary skill having the benefits of the present disclosure.

Turning now to FIG. 5, filter system 100 may be coupled to vacuum cleaner 10 (FIG. 1A), for example, so that at least a portion of the one or more cleaning assemblies 102 are disposed inside drum 12, as will be further described below. For example, first end 126 of filter cage 110 may be coupled to lid 30, which may include sealingly engaging lid 30, such as when the lid 30 is coupled to collection drum 12. In at least one embodiment, which is but one of many, lid 30 may have an opening there through and filter system 100 may include a cap, such as a filter cap 32, for coupling to lid 30 and sealingly engaging first end 126 of filter cage 110.

Filter cap 32 may include one or more latches 36 for coupling to one or more latch couplers 132 on lid 30, but need not, and alternatively, or collectively, filter cap 32 may otherwise engage lid 30, such as threadably or with complementary couplers, such as notches, grooves, or other couplers. Filter system 100 may include one or more filters 134, which may include a filter 134 coupled to each filter cage 110 in a particular filter system 100. Filter 134 may be tubular and may include a first end 136, a second end 138, and a filter element 140 coupled there between. Filter 134 may include a central opening (not shown), such as an air passage, for coupling with cleaning assembly 102, which may include an inner surface 144 configured to be disposed about filter cage 110, such as adjacent to one or more peripheral openings 124, which may, but need not, include contact between filter 134 and filter cage 110, in whole or in part.

First end 136 of filter 134 may include one or more seals 146 (as shown in FIG. 6A), such as a urethane seal, for sealingly engaging filter cap 32, lid 30, or filter cage 110. In at least one alternative embodiment, which is but one of many, first end 136 and one or more seals 146 may cooperate to take place of filter cap 32, in whole or in part. For example, filter cap 32 and filter 134 may be coupled to one another, including being formed integrally, which may reduce the amount of parts or costs for one or more embodiments of filter system 100, such as for a commercial embodiment. Second end 138 of filter 134 may include one or more seals 146B (as shown in FIG. 6C), such as a urethane seal, for sealingly engaging flange 112 of plenum 116. Seal 1468 would then perform the function of seal 118 described earlier.

The filters, such as filter 134, suitable for use in the assemblies of the present disclosure, may be of the pleated type as illustrated, or may be non-pleated, and may be made of any number of suitable filtration materials for filtering/removing at least some debris or other media out of the air passing there through. The filter 134 can be made from one or more of the following exemplary materials including, but not limited to: paper; cloth; glass-fiber materials; split-fiber materials; solution-spun fibers and materials made from such fibers; felt materials; natural fiber filter material; expanded polytetrafluoroethylene (PTFE) membranes; expanded ultra high molecular weight polyethylene (PE) membranes and materials; melt-blown media, such as melt-blown polypropylene (PP) or melt-blown polyethyelene (PE); microporous open cell polymers, such as polyurethane foam; poly(ethylene terephthalate), (PET) or polyphenylene sulfide (PPS) based materials, as well as copolymer-based materials thereof; HEPA-type materials and related fiber or randomly-arranged fiber materials (high-efficiency particulate air (HEPA) filters being those filters that can remove at least 99.97% of airborne particles 0.3 micrometers (μm) in diameter) in accordance with NIOSH requirements; triboelectrified media and materials, and the like, any of which may be treated so as to be hydrophobic and/or have mold and mildew preventative characteristics. Such treatments may be especially desirable for those filter assemblies manufactured for use in wet/dry vacuum cleaners.

Further, filter 134 may be folded or pleated, or it may be non-folded, as appropriate. Preferably, in accordance with one aspect of the present disclosure, and regardless of which material is used to form filter 134, the filter material may be folded into multiple pleats and formed into a generally cylindrical or tube-like shape having a “rippled” or “pleated” appearance to increase the exposed surface area. This folding increases the area of the filter 134 that is in contact with the airstream during vacuum appliance operation, thus effectively improving the filtration without decreasing the airflow. The filters 134 may also have a variety of porosities, or pore size distributions, depending upon the desired airflow permeability to be achieved. Exemplary porosities include, but are not limited to, about 1 micron, about 3 micron, and about 10 microns, as well as porosities greater than or less than these values, e.g., about 0.1 microns, and about 15 microns.

With reference to FIGS. 6A-6H, filter system 100 may include a valve assembly for selectively switching between airflow paths, such as a vacuum air flow path and a filter cleaning air flow path, which will be described in detail below. Valve assembly 200 may include one or more valves, such as a backflush valve 202 (shown in detail in FIG. 6G) and an inlet valve 204 (detailed in FIG. 6H), coupled to a cleaning actuator 206 (detailed in FIG. 6F), which may be singular, or one of multiple actuators within the system. Backflush valve 202 may be coupled to the first end 126 of filter cage 110 for selectively allowing fluid communication between the interior of drum 12 and an atmosphere surrounding vacuum cleaner 10 (FIG. 1A), such as ambient air.

As shown in the exemplary embodiment of FIG. 6G, for example, backflush valve 202 may include a shoulder sealing region 222 removably and sealingly coupled to a backflush port 224 (FIG. 6B), but need not, and may alternatively be any type of valve required by a particular application, as will be understood by one of ordinary skill. Backflush valve 202 also includes a formed opening 205 (FIG. 6G) having upward and downwardly extending walls along the vertical axis of the valve and extending through the entire valve, the opening 205 being shaped and sized to accommodate the movement of cleaning actuator 206 (FIG. 6F) there through, while simultaneously supporting cleaning actuator 206 when not in use. Furthermore, backflush valve 202 can include a top portion 203. The top portion 203 can be adapted to couple to actuator handle 212 (as shown in FIG. 6B).

Backflush port 224 (FIG. 6B) may be coupled to first end 126 of filter cage 110, including being formed integrally therewith, and may include a top surface 226 for engaging a seal surface 228, such as a bottom surface of lid 30, filter cap 32, or another component of vacuum cleaner 10 (FIG. 1A), for example, to form an air tight seal there between. One or more seals or sealants (not shown) may, but need not, be coupled to top surface 226, or proximate thereto (e.g., seal 146). Backflush valve 202, and inlet valve 204 (FIG. 6C) described below, may be formed in any manner and from any material required by a particular application, in whole or in part. For example, the components may be molded, machined or otherwise formed from plastic, metal, composite, or another material, separately or in combination. While some components may be formed integrally, others may be formed separately and otherwise coupled together, which may include the use of fasteners, such as screws, clips, brackets, adhesives, or other couplers.

As shown in the exemplary embodiment of FIGS. 6A-6D, for example, valve assembly may include an inlet valve 204 fluidicly coupled between the bottom end 128 of filter cage 110 and plenum outlet 122 for selectively allowing fluid communication between filter cage 110 and vacuum outlet 38. As shown for illustrative purposes, inlet valve 204 may be coupled inside plenum 116, but it need not be, and may alternatively be coupled to plenum inlet 120, plenum outlet 122, flange 112, or in another location fluidicly between filter cage 110 and vacuum outlet 38 required by a particular application.

As shown in FIG. 6H, inlet valve 204 includes a slightly arcuate upper surface 230, and a hinge assembly 207 to allow the valve to be hingedly coupled about a pivot point, such as pivot point P (FIG. 6C), which may be any point which will allow inlet valve 204 to function as described herein, as will be understood by one of ordinary skill in the art (e.g., inlet valve 204 could rotate about its opposite end, or about another point on plenum 116).

When open, inlet valve 204 may allow air to flow between inlet 120 and outlet 122, as will be further described below, and may, but need not, be supported by a support, for example, bump stop 232 (as shown in FIG. 6C), such as for defining an extent to which inlet valve 204 may rotate about pivot point P in an open direction. When closed, inlet valve 204 may at least partially prevent fluid communication between inlet 120 and outlet 122, for example, by sealingly engaging a surface, such as plenum inlet sealing surface 234, which may, but need not, include seals or sealants (not shown) coupled there between.

The upper surface 230 of inlet valve 204 may include structure for coupling to or interacting with actuator 206 (FIG. 6F as further described below), which may include a hole, such as slot 236 (FIG. 6H) extending through the inlet valve 204, for allowing actuator 206 to pass there through. However, the upper surface 230 of valve 204 need not have a hole there through, and may alternatively have a solid cross-section with structure coupled to the top and/or bottom for communicating with one or more other components, such as, for example, actuator 206 or biasing device 220 (FIG. 6C as described below), as will be understood by one of ordinary skill have the benefits of this disclosure. It will also be understood that inlet valve 204, like back flush valve 202, may be any type of valve required by a particular application, and valves 202, 204 may, but need not, be the same type of valve.

In at least one embodiment, such as the one shown in FIGS. 6A-6D and 6F, which is but one of many, actuator 206 may include a shaft 208 having a first end 210, which may, but need not, include an actuator handle 212, coupled to backflush valve 202 (FIG. 6A) and a longitudinally opposite second end 214 coupled to inlet valve 204 (FIG. 6A). Actuator 206 may be slideably coupled relative to lid 30 or filter cap 32 for manipulating valves 202, 204, as will be further described below.

For example, valve assembly 200 may include one or more actuator supports 216 for slideably supporting actuator 206. Each actuator support 216 may be coupled anywhere within cleaning assembly 102 (FIG. 4A), for example, to filter cage 110 or plenum 116, and may, but need not, include one or more bearings 218 (e.g., FIG. 6B), such as linear or slide bearings. Alternatively, one or more supports 216 may have a hole, opening, or notch for allowing actuator 206 to pass there through or thereby. Valve assembly 200 may, but need not, be biased in a particular position, and may include one or more biasing devices 220, such as a spring, coupled to actuator 206, backflush valve 202, or inlet valve 204, separately or in combination.

As shown, for example in FIGS. 6A and 6B, for illustrative purposes, at least one embodiment, which is but one of many, may include a biasing device 220, such as a tension spring, having one end coupled to plenum 116 and another end coupled to second end 214 of actuator shaft 208. Actuator 206 may include structure for communicating with inlet valve 204 (FIG. 6H), for example as inlet valve 204 opens and closes, such as a pin 238 or other structure coupled to shaft 208 below slot 236, which may prevent actuator 206 from becoming uncoupled from inlet valve 204 (FIG. 6H) and allow inlet valve 204 to rotate between open and closed positions.

Actuator 206 may further include, separately or in combination, a stop boss 240 (FIG. 6C), such as a pin, shoulder, or other protrusion coupled above upper surface 230, which may, for example, communicate with upper surface 230 to move or hold inlet valve 204 in a particular position, such as an open position. As will be understood by one of ordinary skill, pin 238 and stop boss 240, for example, may cooperate to moveably couple inlet valve 204 with actuator 206, which may allow inlet valve 204 to open and close as actuator 206 moves back and forth (e.g., up and down as illustrated in FIGS. 6A-6D), and as further described below.

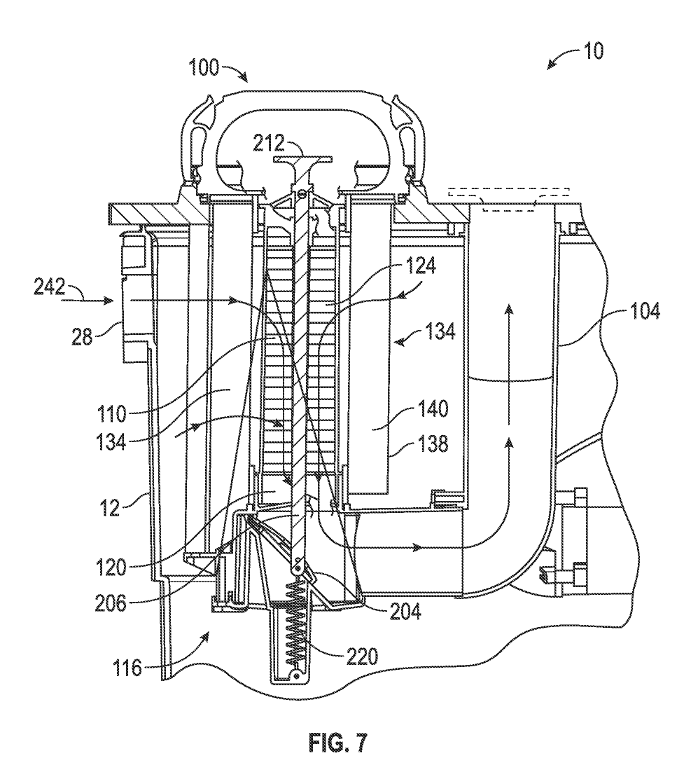

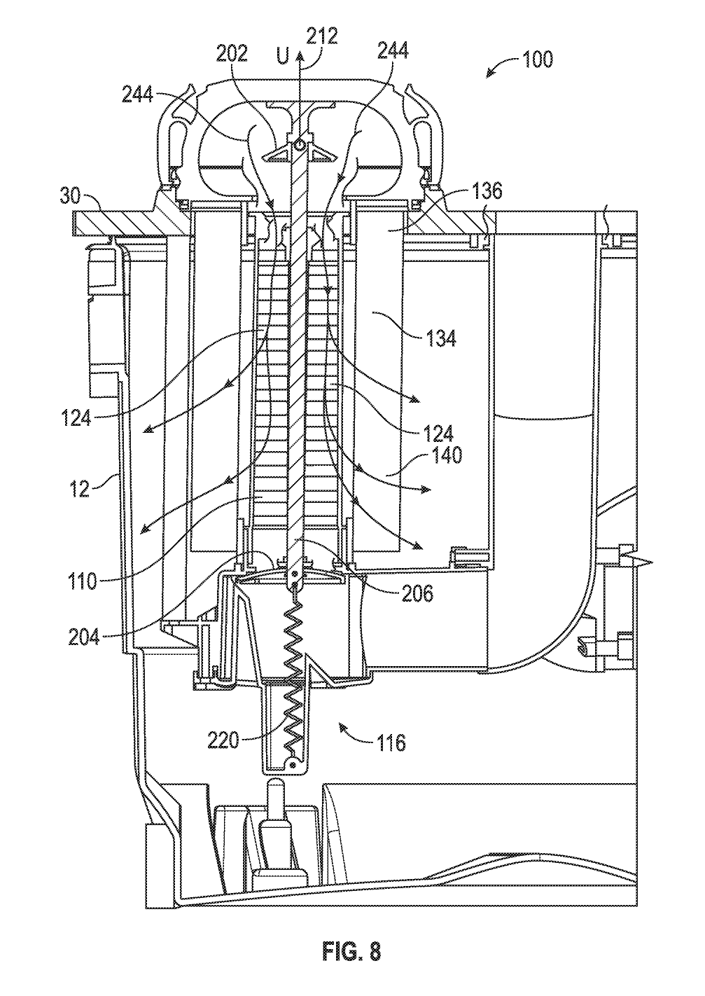

FIG. 7 is a schematic illustration of one of many embodiments of vacuum cleaner 10 having a filter system 100 in a vacuum position and utilizing certain aspects of the present invention. FIG. 8 is a schematic illustration of the filter system 100 of FIG. 7 in a cleaning position. FIGS. 7 and 8 will be described in conjunction with one another.

FIG. 7 shows one of many embodiments of filter system 100 in a normal, or vacuum, position, such as when vacuum cleaner 10 is operated in a Vacuum Mode. In the vacuum position, filter system 100 may define a first airflow path 242 through the system, such as a vacuum air flowpath, as indicated, for example, by the arrows in FIG. 7, and described below. When filter system 100 is in the vacuum position, backflush valve 202 may be closed and inlet valve 204 may be open, which may, but need not, include being biased in said positions by actuator 206 and biasing device 220, as described above.

A vacuum source, such as powerhead 14 (FIG. 1A), may be energized and vacuumed air, along with any vacuumed debris, may flow into drum 12, such as through vacuum inlet 28. The air may flow in a first direction (i.e., from the exterior to the interior) through filter 134, and at least some of the debris may be filtered out of the air by filter element 140, such as by sticking thereto. The air may pass through filter cage 110, and further along first airflow path 242 through second end 138 of filter 134, and through plenum 116 and inlet valve 204. The air may exit plenum 116 and travel through intake manifold 104 to the vacuum source (not shown) to be expended back into the atmosphere. In the embodiment shown for illustrative purposes in FIG. 7, which is but one of many, filter system 100 is coupled vertically with vacuum cleaner 10 and the vacuumed air flows downwardly along at least a portion of first air flow path 242, such as between one or more peripheral openings 124 in filter cage 110 and plenum inlet 120. However, this need not be the case, and filter system 100 may alternatively be disposed horizontally, or at another angle, which may be any angle required by a particular application.

Referring now to FIG. 8, filter system 100 is shown in one of many filter cleaning positions. In a cleaning position, filter system 100 may define a second airflow path 244 through the system, such as a filter cleaning airflow path, as indicated, for example, by the arrows in FIG. 8, and described below.

When a user desires to clean filter 134, such as by removing at least some of the debris that may accumulate on filter element 140 during vacuuming, actuator 206 may be actuated, for example, by grasping actuator handle 212 and moving actuator 206 in an actuating direction (e.g., in the upward direction as illustrated in FIG. 8) as indicated by the arrow U in FIG. 8. When filter system 100 is in a cleaning position, backflush valve 202 may be open and inlet valve 204 may be closed, which may, but need not, require application of an actuating force sufficient to at least partially overcome a biasing force of biasing device 220, if present. Inlet valve 204 may at least partially prevent airflow there through, and open backflush valve 202 may allow ambient air (e.g., air at atmospheric pressure) to flow into drum 12. Air may flow through first end 136 of filter 134, into filter cage 110, and through one or more peripheral openings 124.

Air may continue along second airflow path 244 in a second direction (i.e., from the interior after the air flows past filter cap 32 to the exterior) through filter 134, which may dislodge at least some of the debris from filter element 140, which may be collected in drum 12. Filter system 100 may be held in a cleaning position for any amount of time required by a particular application. For example, for light debris accumulation, a relatively short cleaning time may be required. For instance, for light vacuum applications, such as routine cleaning in or around a household, the elapsed time between cleaning cycles may be relatively long because the rate in which debris can accumulate on the filter 134 is relatively low. In other applications, such as commercial applications, the elapsed time between cleaning cycles may be relatively shorter because the rate in which debris can accumulate is much faster and, therefore, the time between cleaning cycles can be shortened, to remove the accumulated debris before the filter 134 become clogged from excess debris. In an embodiment of vacuum cleaner 10 having more than one filter system 100, such as one of many preferred embodiments having two filter systems 100, one filter system 100 may be in the vacuum position while the other filter system 100 is in a cleaning position, such as the one described above.

As will be understood by one of ordinary skill having the benefits of this disclosure, the magnitude of vacuum inside drum 12 may be reduced when a backflush valve 202 is open, such as due to ambient air entering drum 12. However, a vacuum may still be present in drum 12, for example, due to the second filter system 100 being in a vacuum position, which may allow vacuum operations to continue during cleaning of a particular filter 25 (FIG. 1A). After cleaning, filter system 100 may return to a vacuum position, such as, for example, when the user releases actuator handle 212 or otherwise closes backflush valve 202 and opens inlet valve 204. In an embodiment having a biasing device 220, such as the embodiment of FIGS. 7 and 8, which is but one of many, biasing device 220 may return valves 202, 204 to their vacuum positions, which may thereby reestablish first air flow path 242, such as the path illustrated in FIG. 7. Cleaning of one or more filters 134 in a particular vacuum cleaner 10 may occur at any time, and as often as required by a particular application.

Backflush Mode

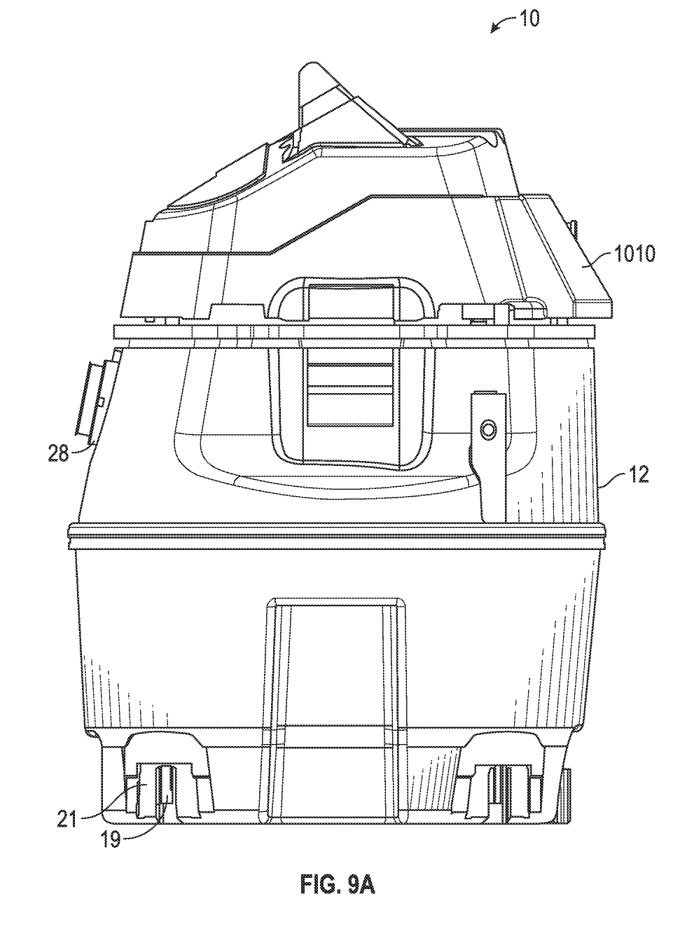

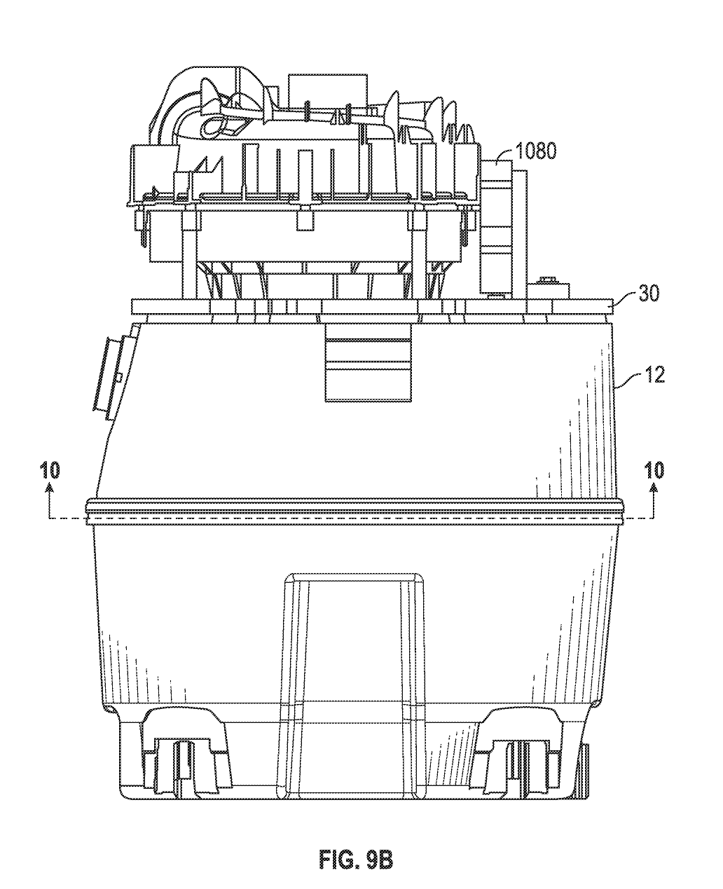

The vacuum cleaner 10 described in connection with FIGS. 1-8 may be configured to take alternative forms and designs as well. For example, the vacuum 10 as disclosed in FIGS. 1-8 can be configured in a “Backflush Mode.” In Backflush Mode, the vacuum's 10 backflush valve (e.g., as shown in FIG. 6A, element 202) and control mechanisms and the like (e.g., vacuum manifold, spring caps, inlet valves, actuator plunger, etc.) can take modified forms in order to provide apparatuses and systems that are adapted to clean the filter (e.g., FIG. 1B, element 25) using a backflush method. The backflush method can be adapted to allow air at its ambient atmospheric pressure to enter the filter area (e.g., FIG. 1B, element S) in order to reverse its flow through the filter 25 to remove debris from the filter 25. In embodiments where more than one filter is employed, one or more filters can be operated in “Vacuum Mode,” for example, as described in reference to FIG. 7, while at least one filter is in “Backflush Mode.” These particular embodiments may be better understood with reference to FIGS. 9-16 in combination with the detailed description of specific embodiments presented herein.

For FIGS. 9-16, many, but not all, of the illustrated features of the described inventions share features with the embodiments described in FIGS. 1-8, above. For example, referring specifically to FIG. 9A, the exemplary vacuum cleaner 10 illustrated in this Figure shares many common elements with the exemplary vacuum cleaner in FIG. 1A (e.g., drum 12, casters 19, drum mounts 21, vacuum inlet 28, etc.). All of these features are described in detail with reference to FIGS. 1-8 and thus, in the interest of clarity and brevity, will not be repeated for the description for FIGS. 9-16.

Moreover, several features described with reference to FIGS. 1-8 are illustrated in one or more of FIGS. 9-16, but not specifically labeled for these embodiments. One of ordinary skill in the art, therefore, would understand that similar features illustrated in FIGS. 9-16 share common features, descriptions, embodiments as those features illustrated and described with reference to FIGS. 1-8. Although the portions of the disclosure describing FIGS. 9-16 mainly focus on the differences of those elements previously described with reference to FIGS. 1-8, one of ordinary skill in the art would recognize that one or more of the elements described in reference to FIGS. 9-16 can be similarly embodied, where appropriate, as those elements described in reference to FIGS. 1-8.

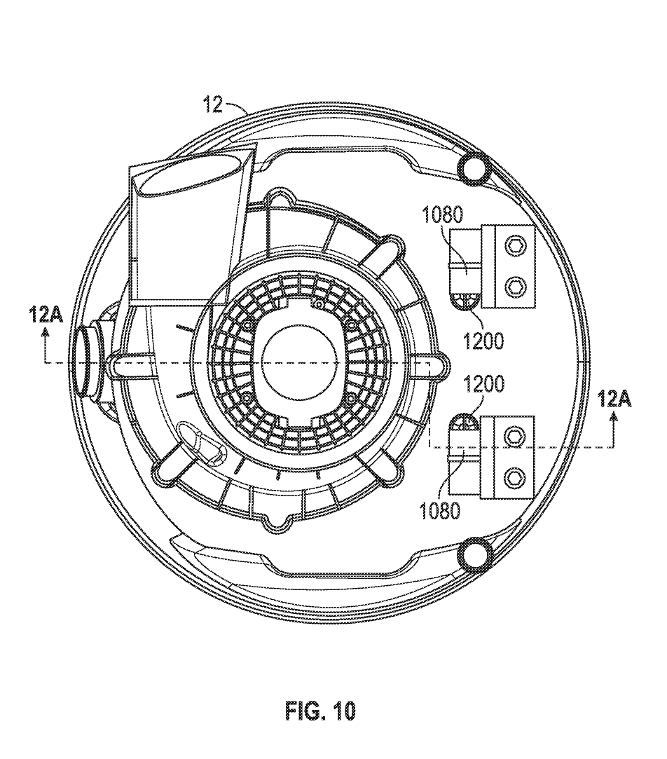

FIG. 9A illustrates a schematic side view of a second embodiment of an exemplary vacuum cleaner of the present disclosure. FIG. 9B illustrates a schematic side view of a vacuum cleaner of FIG. 9A with the motor cover removed. FIG. 10 illustrates a schematic top view of the vacuum cleaner of FIG. 9A with the motor cover removed. These Figures will be described in conjunction with one another.

Vacuum cleaner 10 can include a drum 12, and a powerhead 14. The powerhead 14 can include a lid 30, a motor cover 1010, or some kind of access covering coupled to the drum 12 in order to gain access to the motor (not shown). For example, the powerhead 14 can include a removable cover coupled to the drum 12, either through one or more hinges, latches, or the like to couple the powerhead 14 to, and uncouple it from, the drum 12.

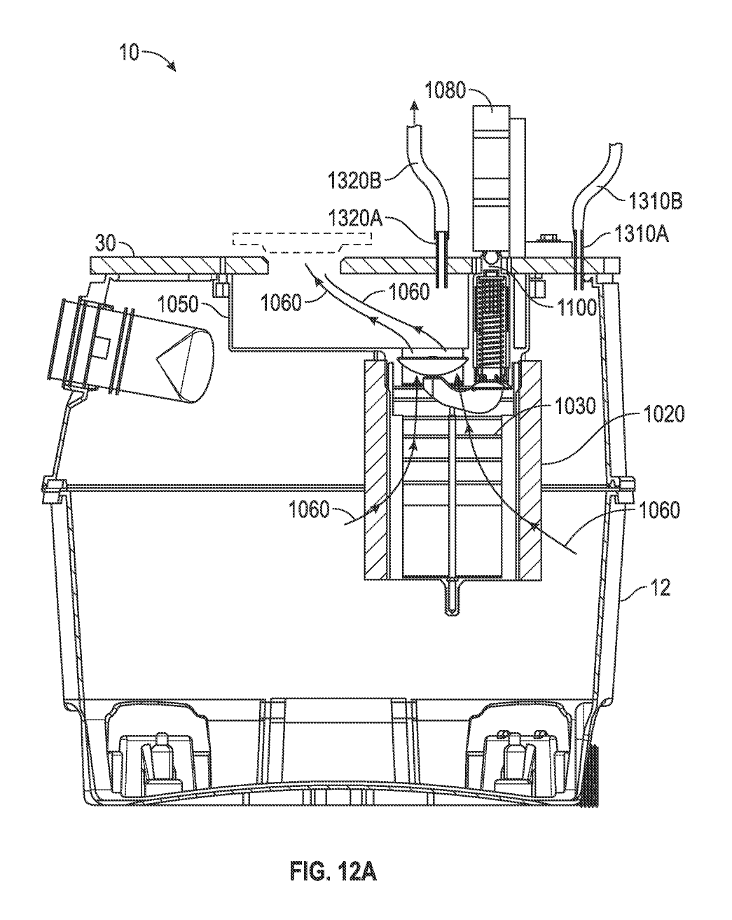

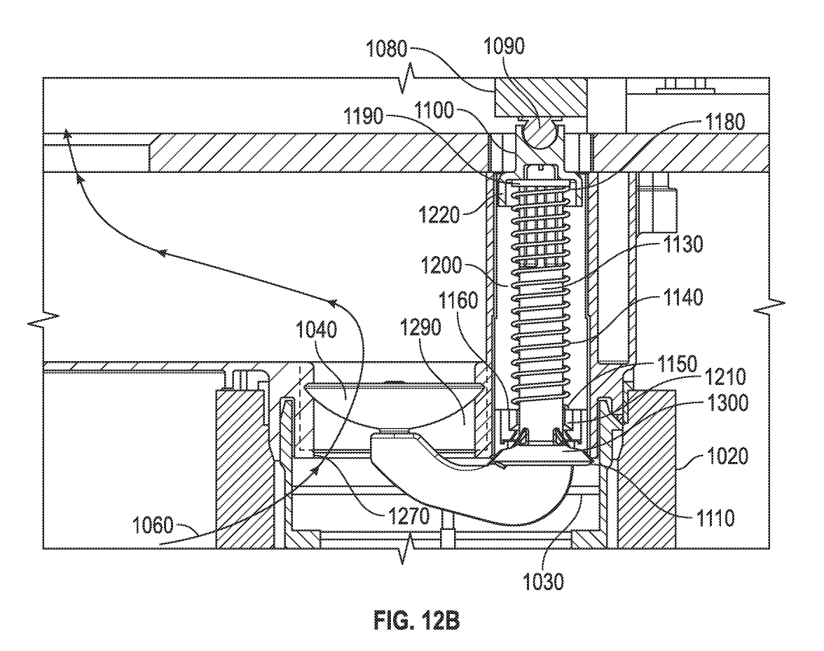

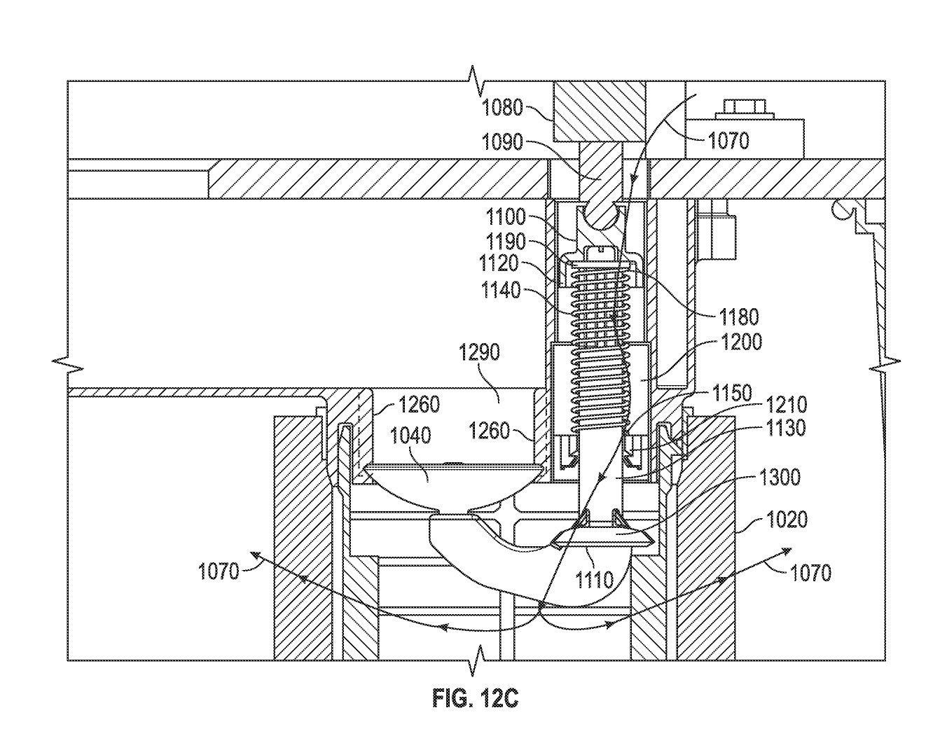

With the motor cover 1010 removed, the actuator 1080 is visible. In an exemplary and non-limiting illustrative embodiment, the actuator 1080 can include an electronic actuator. For example, the actuator 1080 can include an actuator driven or powered by electronics, such as control logic (not shown). The control logic can include a processor, a control unit, a circuit board, hardware, software, firmware, other logic, or any combination thereof. Furthermore, the actuator 1080 can include a solenoid, an electronic motor-driven actuator, or the like for automatically driving the actuator plunger 1090, through electrical, magnetic, or electromagnetic force (described in greater detail in FIG. 12B).

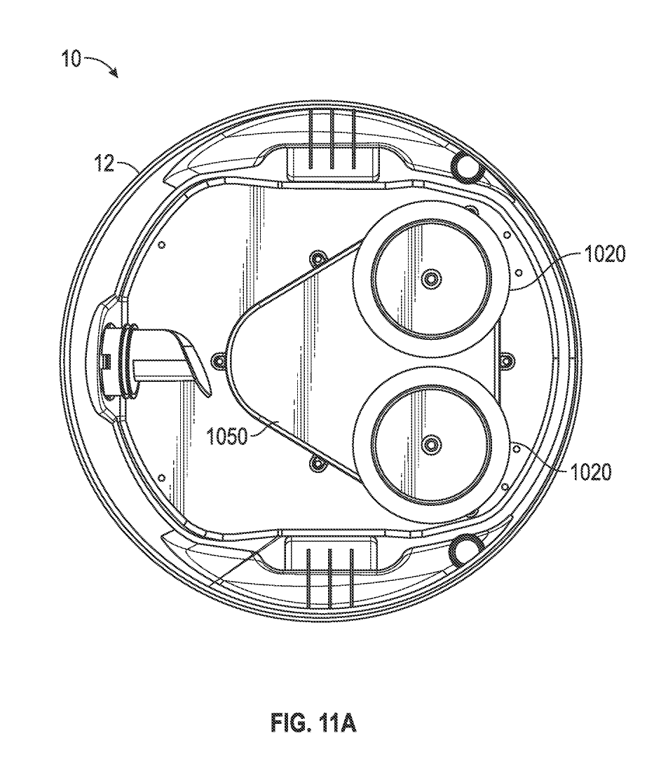

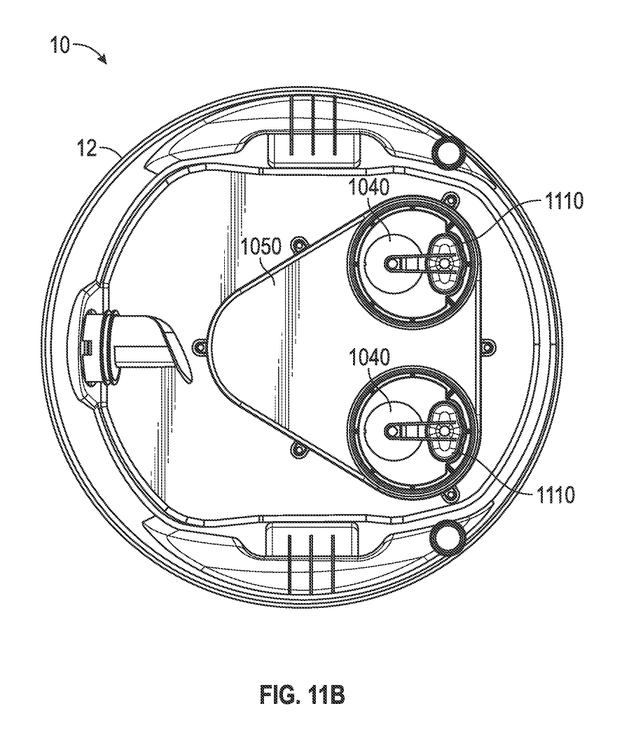

FIG. 11A illustrates a schematic cross sectional view through line AA-AA of FIG. 9B illustrating a second embodiment of a filter assembly installed in a vacuum cleaner. FIG. 11B illustrates a schematic cross sectional view through line AA-AA of the filter system of FIG. 10 installed in a vacuum cleaner with the filters removed. These Figures will be described in conjunction with one another.

The control logic (not shown) can be embodied on a computer readable medium (not shown). For example, the control logic can include any instructions, such as a program or application, that can be performed or executed by a computer or processing unit. The control logic can further include executable, non-executable, assembly, machine, compiled, or uncompiled code, or any other instructions that can be read by a computer.

Furthermore, the computer readable medium (not shown) can refer to any storage medium that may be used in conjunction with the control logic or other computer readable instructions. In an exemplary and non-limiting illustrative embodiment, the computer readable medium can include a computer readable storage medium. The computer readable storage medium can take many forms, including, but not limited to, non-volatile media and volatile media, floppy disks, flexible disks, hard disks, magnetic tape, other magnetic media, CD-ROMs, DVDs, or any other optical storage medium, punch cards, paper tape, or any other physical medium with patterns of holes. Computer readable storage media can further include RAM, PROM, EPROM, EEPROM, FLASH, combinations thereof (e.g., PROM EPROM), or any other memory chip or cartridge.

The computer readable medium can further include computer readable transmission media. Such transmission media can include coaxial cables, copper wire and fiber optics. Transmission media may also take the form of acoustic or light waves, such as those generated during radio frequency, infrared, wireless, or other media comprising electric, magnetic, or electromagnetic waves.

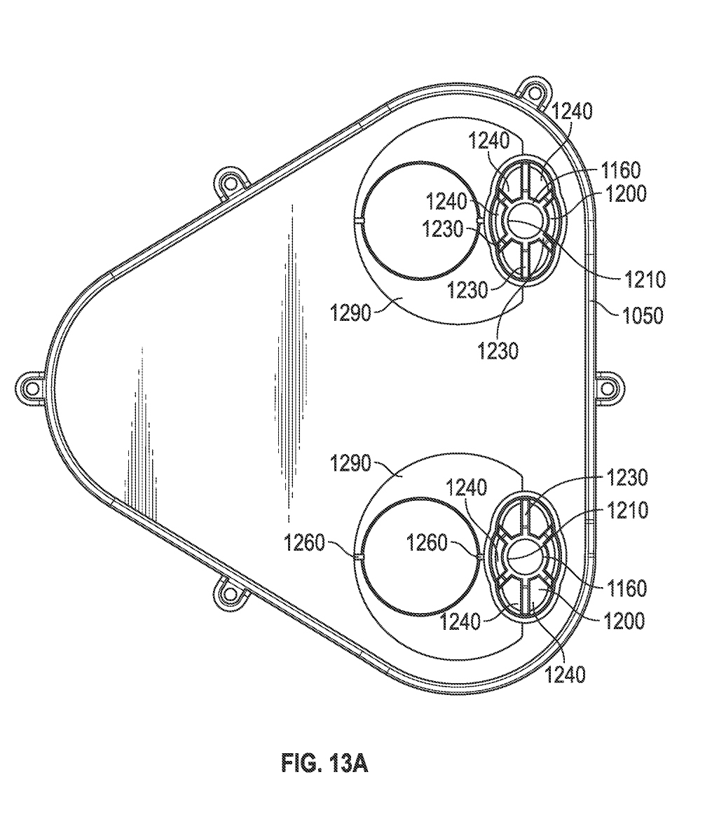

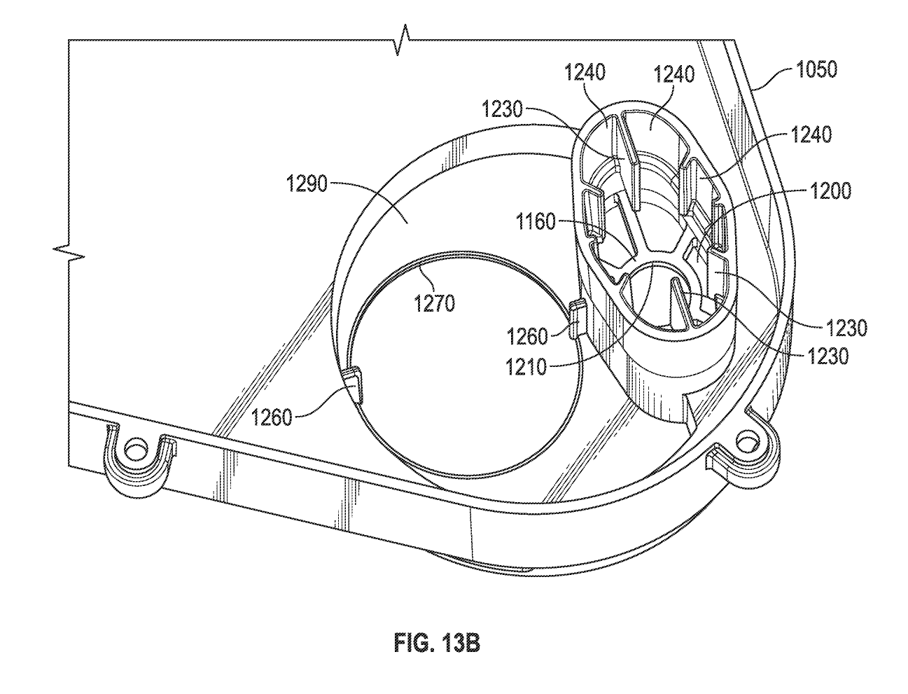

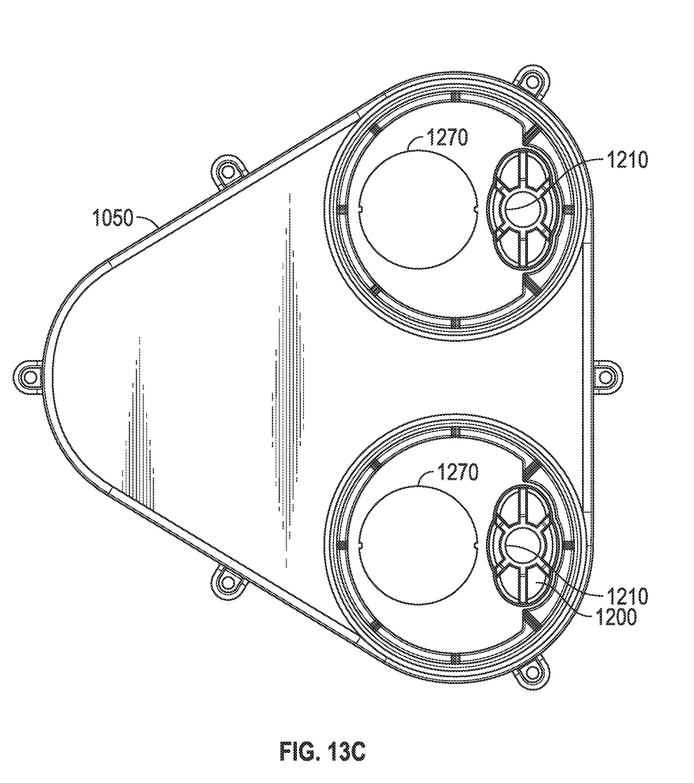

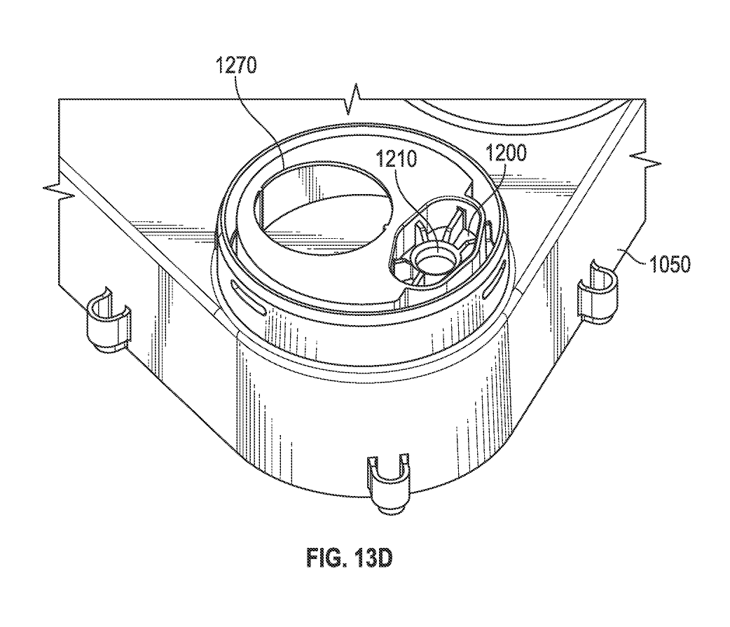

Vacuum cleaner 10 can include one or more filters 1020. For example, in one embodiment, vacuum cleaner 10 includes two filters 1020. In this embodiment, one filter 1020 can be used in Vacuum Mode (as described in greater detail with reference to FIGS. 12A and 12B) while the other filter 1020 can be used in Backflush Mode (as described in greater detail with reference to FIG. 12C). Drum 12 can further include vacuum manifold 1050 to assist with the airflow within vacuum cleaner 10. For example, air can flow through the slots of filter cage 1030 (as shown in FIG. 12A) and through inlet port 1270 (as shown in FIG. 13B), past inlet valve 1040, through vacuum manifold 1050, to the vacuum source, such as a blower wheel (not shown).

FIG. 12A illustrates a schematic cross sectional view through line BB-BB of the vacuum cleaner of FIG. 10. FIG. 12B illustrates an enlarged view of a valve area of the schematic cross sectional view through line BB-BB of the vacuum cleaner of FIG. 12A. FIG. 12C illustrates an enlarged view of a valve area of the schematic cross sectional view through line BB-BB of the vacuum cleaner of FIG. 12A in Backflush Mode. These Figures will be described in conjunction with one another.

During Vacuum Mode, vacuumed air can follow through a third airflow path 1060, such as a vacuum airflow path, as indicated, for example, by the arrows in FIGS. 12A and 12B. For example, through the third airflow path 1060, air can flow into the drum 12 and through one or more filters 1020. For example, this can occur with air flowing from atmospheric pressure of the ambient air to the negative relative pressure of the vacuum 10. Next, air can flow through the slots of filter cage 1030 (as shown in FIG. 12A) and through inlet port 1270 (as shown in FIG. 12B), past inlet valve 1040, through vacuum manifold 1050, to the vacuum source, such as a blower wheel (not shown). The guide ribs 1260 of manifold 1050 (as shown in FIG. 13B) can further help guide the inlet valve 1040 in order to properly align it with inlet port 1270 (as shown in FIG. 12B).

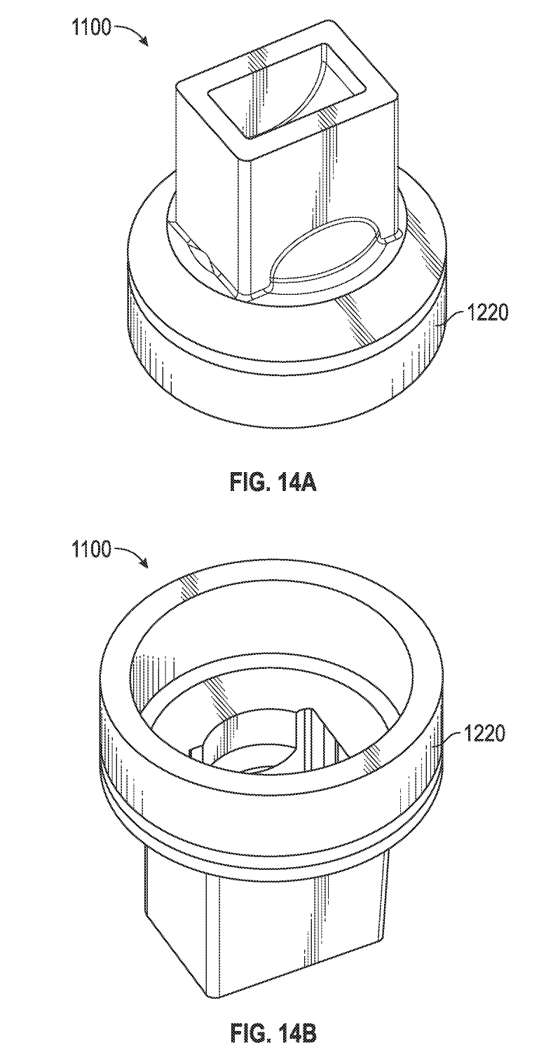

Furthermore, inlet valve 1040 fastens backflush valve 1110 with a fastener (not shown) such as screws, brackets, adhesives, or other couplers. Additionally, backflush valve 1110 can include a stem 1130 with a biasing device 1140, such as a compression spring, housed around the stem 1130. A first end 1150 of biasing device 1140 can be seated against a biasing device seat 1160. In one example, the biasing device seat 1160 can be located in backflush port 1200. The backflush port 1200 can further include a bearing 1210 that can be used to guide stem 1130 of the backflush valve 1110 through a linear motion. A second end 1180 of the biasing device 1140 can be trapped in its position with the aid of a washer 1190. The washer 1190 can be fastened or coupled to the stem 1130 of backflush valve 1110 with a fastener, such as screws, brackets, adhesives, or other couplers. By doing so, the biasing device 1140 can be placed in a compressed state, thus biasing the backflush valve 1110 in a closed position. Similarly, this compressed state places the inlet valve 1040 in an open position until acted upon at a later time by the plunger 1090 or the actuator 1080. Furthermore, the washer 1190 can be arranged adjacent to the outer flange 1220 (described in greater detail in reference to FIGS. 14A and 14B).

Vacuum cleaner 10 can toggle from Vacuum Mode to Backflush Mode (e.g., as shown in FIG. 12C) in response to one or more conditions being met. For example, this toggling can occur through a time-elapsed procedure, or in the alternative, a pressure differential procedure. For the time-elapsed procedure, the vacuum cleaner 10 can include a timer (not shown) for determining the amount of time since a particular filter 1020 was previously cleaned. For example, the control logic (not shown) can include internal circuitry and/or programming for counting and/or timing the amount of time that has elapsed since the filter 1020 was previously cleaned. In the alternative, the timer can include a feature for timing the absolute amount of time the filter 1020 has been installed in the vacuum cleaner 10. In this example, the user will be able to track the amount of time since the particular filter 1020 was replaced. In another example, the timer (not shown) can be used to count both the amount of time since the last cleaning and the amount of time since the filter 1020 was replaced.

In the alternative, toggling from Vacuum Mode to Backflush Mode can occur in response to the pressure differential procedure. The pressure differential procedure is adapted to determine the pressure differential between the vacuum cleaner 10 in the drum 12 and the vacuum in the vacuum manifold 1050. Because the vacuum manifold 1050 is on the “clean side” of the filter 1020, a pressure differential would indicate a dirty filter due to an increased accumulation of debris on the filter 1020. Furthermore, manifold 1050 can further include a recessed pocket 1290 that can work to position the backflush valve 1110 inboard in the drum 12 area and adjacent to the filter 1020. For example, if filter 1020 is a pleated-type filter the backflush valve 1110 can be adjacent to the filter's 1020 pleats so as to increase the amount of airflow to the pleats for cleaning. Additionally, the sealing surface 1300 of the backflush valve 1110 can be placed inside the drum 12 cavity to permit it to open away from the manifold 1050 and towards the filter 1020.

To detect vacuum pressures and pressure differentials, two or more pressure taps (1310A and 1320A) and two or more conduits (1310B and 1320B) can be employed. For example, conduit 1310B can be coupled to the drum 12 (to facilitate the measurement of the vacuum pressure in the drum 12) and conduit 1320B can be coupled to the vacuum manifold 1050 (to facilitate the measurement of the vacuum pressure on the “clean side” of filter 1020). In one embodiment, the pressure taps 1310A and 1320A and conduits 1310B and 1320B can be adapted to pass through the lid 30. Each of the conduits 1310B, 1320B can further be coupled to one or more pressure switches or actuators (not shown). The pressure switches can be adapted to be sensitive to pressure differentials and pressure changes. In one example, the pressure differential can cause the pressure switches to actuate, thus triggering the Backflush Mode as described below.

In one example, the control logic (not shown) can be adapted to determine or calculate the pressure differential as measured between the pressure taps 1310A, 1320A and the conduits 1310B, 1320B. By doing so, the control logic can send a signal to enter Backflush Mode after a pressure drop was calculated to be sufficient to significantly reduce the performance of the suction of the air stream.

Once one or more of the previously described conditions are met, vacuum cleaner 10 can toggle from Vacuum Mode to Backflush Mode. For example, if triggered through the pressure differential procedure as described above, first the actuator 1080 can be energized or powered via the control logic (not shown) as described above. The actuator 1080 can be energized or powered in response to one or more conditions being met as described in greater detail below. Once powered or energized, the actuator plunger 1090 can extend against and push the spring cap 1110 that in turn can push against and open the backflush valve 1110 while simultaneously closing the inlet valve 1040. In other words, the inlet valve 1040 can be configured to move as the backflush valve 1110 moves (i.e., as the blackflush valve 1110 opens, the inlet valve 1040 closes and vice-a-versa).

With the blackflush valve 1110 in the open position, ambient air can flow through a fourth airflow path 1070, as indicated, for example, by the arrows in FIG. 12C. For example, ambient air can flow past the actuator 1080 and the actuator plunger 1090. The airflow path 1070 can continue past the washer 1190 and through the backflush port 1200 and out past the backflush valve 1110. Subsequently, the airflow path 1070 can flow through the filter 1020 (such as through pleats for a pleated-type filter) and to one or more filters 1020 operating in Vacuum Mode (in an embodiment with two or more filter assemblies—e.g., as shown in FIG. 4A, element 100). By doing so, the filter 1020 can be cleaned from the resulting airflow by being backflushed through the vacuum cleaner 10.

The vacuum cleaner 10 can toggle back from Backflush Mode to Vacuum Mode upon the occurrence of one or more conditions. For example, the operation of the actuator 1080 can be configured based on the control logic (not shown) adapted to de-energize or power down the actuator 1080 based upon a preset period of time as controlled by the control logic. In this example, after the preset period of time in which the vacuum cleaner 10 operates in Backflush Mode expires, the biasing device 1140 can return the inlet valve 1040 and the backflush valve 1110 back to their Vacuum Mode positions (i.e., the inlet valve 1040 in the open position and the backflush valve 1110 in the closed position).

In one embodiment with more than one filter 1020, the process of toggling from Vacuum Mode to Backflush Mode and back to Vacuum Mode can repeat in a serial fashion among each of the filters 1020. This can be explained with reference to a specific example where the vacuum cleaner 10 includes three filters (e.g., filters A, B, C) (however a different number of filters can be employed as well). In one example, all filters A, B, and C can begin by simultaneously operating in Vacuum Mode. Once the control logic determines that at least one filter (e.g., filter A) requires cleaning (for example, in accordance with one or more of the conditions being met as described above, such as based on the a pressure differential being detected thus causing the actuation of one or more pressure switches (not shown)), filter A can toggle from Vacuum Mode to Backflush Mode, while filters B and C continue in Vacuum Mode.

Once Backflush Mode completes for filter A (such as, for example, after the expiration of a preset amount of time) it can toggle back to Vacuum Mode while, at the same time, filter B can toggle from Vacuum Mode to Backflush Mode. This process can continue until all filters have been cleaned. In other embodiments, more than one filter can be engaged in Backflush Mode while at least one filter remains in Vacuum Mode. In another embodiment, the toggling need not occur in a serial fashion as described above (e.g., from filter A, to filter B, etc.). In these embodiments, the filters can toggle to and from Vacuum Mode and Backflush Mode manually, in accordance with a user's preferences, or in other patterns based on the requirements of the vacuum cleaner 10 (such as based on triggering each Backflush Mode only when the control logic determines that one filter requires cleaning).

On occasion, one or more of the filters 1020 can accumulate debris to such a degree that the cleaning process available to the user through the Backflush Mode will be insufficient to properly clean the filter. To accommodate for this, the vacuum cleaner 10 can further include a first indicator (not shown) for notifying a user that one or more filters 1020 require manual cleaning and a second indicator (not shown) to indicate that one or more filters need to be replaced. For example, the first indicator can be triggered if debris is heavily caked on or clogging the filter 1020. The second indicator can be triggered based on historical data of that particular filter, such as the length of use in the vacuum cleaner 10, or the number of times it has been cleaned through Backflush Mode.

The control logic (not shown) can execute one or more algorithms to determine if and when a filter may require manually cleaning. For example, a filter 1020 that toggles from Backflush Mode to Vacuum Mode and back to Backflush Mode in a relatively short period of time can suggest that the filter is not being cleaned effectively. The control logic can be programmed to make this determination. Once determined, the control logic can set the first indicator to notify the user to manually clean the filter. The first indicator can include a light, switch, display, or any other audio or visual indication that the filter should be manually cleaned. For example, the first indicator can include a small display screen indicating which specific filter requires manually cleaning.

Likewise, the control logic can be programmed to determine when one or more filters 1020 require replacement. For example, the control logic can be programmed to count the number of cycles a particular filter enters Backflush Mode. In this example, a limit to the number of cycles can be set so that once that threshold is reached, the control logic can determine that the filter requires replacement. In another example, the control logic can determine, either automatically or manually though a user's intervention, the amount of time a particular filter has been in Vacuum Mode, Backflush Mode or a combination thereof. Once the threshold is exceeded, the control logic can trigger the second indicator to indicate to the user that she must replace the filter. For example, the second indicator can include the examples and embodiments as described in conjunction with the first indicator. In another example, the second indicator can include a replace filter indicator, such as through a display or indicator light.

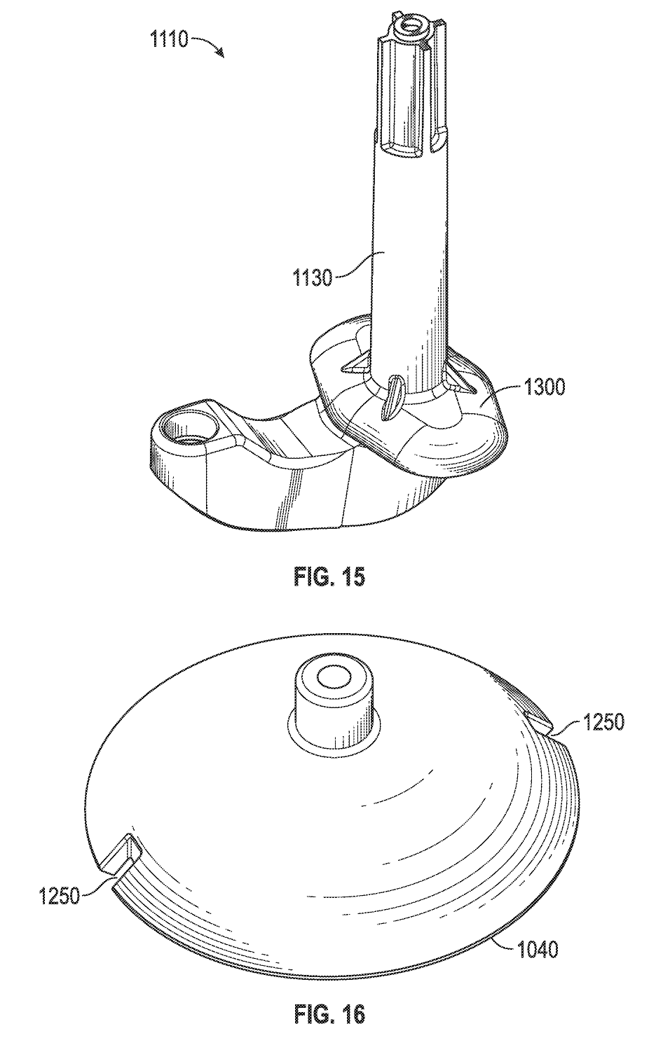

FIG. 13A illustrates a top view of a second embodiment of an exemplary vacuum manifold in accordance with aspects of the present disclosure. FIG. 13B illustrates an enlarged isometric view of the vacuum manifold of FIG. 13A in accordance with aspects of the present disclosure. FIG. 13C illustrates a bottom view of the vacuum manifold of FIG. 13A in accordance with aspects of the present disclosure. FIG. 13D illustrates an enlarged isometric view of the vacuum manifold of FIG. 13C in accordance with aspects of the present disclosure. FIG. 14A illustrates a top isometric view of a spring cap in accordance with aspects of the present disclosure. FIG. 14B illustrates a bottom isometric view of a spring cap in accordance with aspects of the present disclosure. FIG. 15 illustrates an isometric view of a second embodiment of a backflush valve in accordance with aspects of the present disclosure. FIG. 16 illustrates an isometric view of an inlet valve in accordance with aspects of the present disclosure. These figures will be described in conjunction with one another.

Backflush port 1200 can be coupled to the manifold 1050 such that it abuts and/or seals against a corresponding opening in the lid 30 (as shown in FIG. 9B). In one embodiment, the backflush port 1200 can be adapted to be configured mostly from lid 30 such as through forming the backflush port 1200 as part of the lid. In this example, the backflush port 1200 can seal against the manifold 1050. As another example, the backflush port 1200 can be configured in an opposite configuration as the example above where the manifold 1050 abuts and/or seals against the corresponding opening in the lid 30. Additionally, in another example, the vacuum 10 (as shown in FIG. 9A) can be configured such that only a portion of the backflush port 1200 is constructed from the lid 30 and the manifold 1050. In this configuration, the lid 30 and manifold 1050 can be configured such that they form the backflush port 1200 by meeting somewhere between the lid 30 and the manifold 1050. Manifold 1050 can further include a recessed pocket 1290 that can work to position the backflush valve 1110 inboard in the drum 12 area and adjacent to the filter 1020 (as shown in FIG. 11A).

The backflush port 1200 can further include a bearing 1210 that can be used to guide stem 1130 of the backflush valve 1110 in a linear motion. For example, the stem 1130 can be adapted to extend to either lengthen or shorten its distance along a longitudinal axis. The outer flange 1220 of the spring cap 1100 can be adapted to rub against one or more guide ribs 1230 of the backflush port 1200 to aid with this linear motion of the backflush valve 1110. By doing so, the guide ribs 1230 can restrict one or more of the stem's (1130) degrees of freedom by preventing it from tilting or binding. The one or more guide ribs 1230 can also create air passageways 1240 to allow backflush air to flow around the spring cap 1110 and through the backflush port 1200 during Backflush Mode. Inlet valve 1040 can include grooves 1250, such as for aligning the inlet valve 1040 with the inlet port 1270 (as shown in FIG. 13B). The second guide ribs 1260 of manifold 1050 (as shown in FIG. 13B) can further help guide the inlet valve 1040 in order to properly align it with inlet port 1270 (as shown in FIG. 13B).

Referring specifically to FIG. 15, guide stem 1130 can be adapted to be coupled to the sealing surface 1300. The sealing surface 1300 can include gaskets, O-rings, sealants, adhesives, or other seals, stoppers, coverings, or the like for sealing the backflush valve 1110 while seated in the vacuum cleaner 10. For example, the sealing surface 1300 can form an airtight seal at the lower portion of the backflush valve 1110. Alternatively, the sealing surface can form an airtight seal between the backflush valve 1110 and other components of the vacuum cleaner 10.

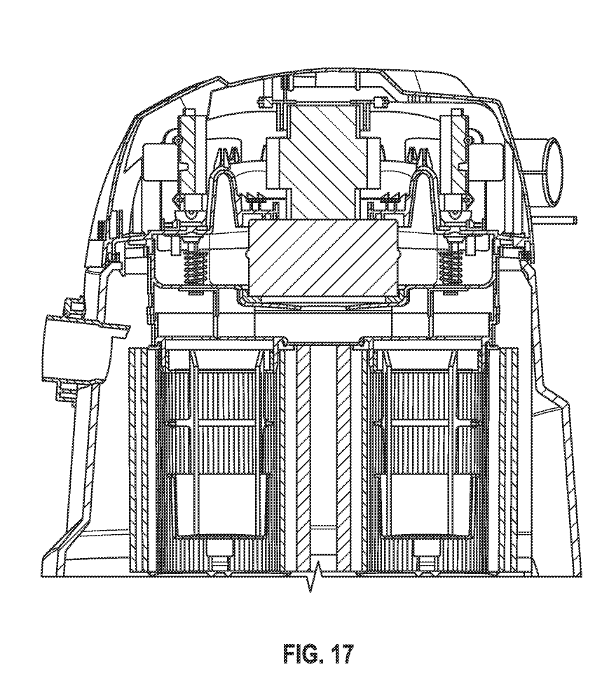

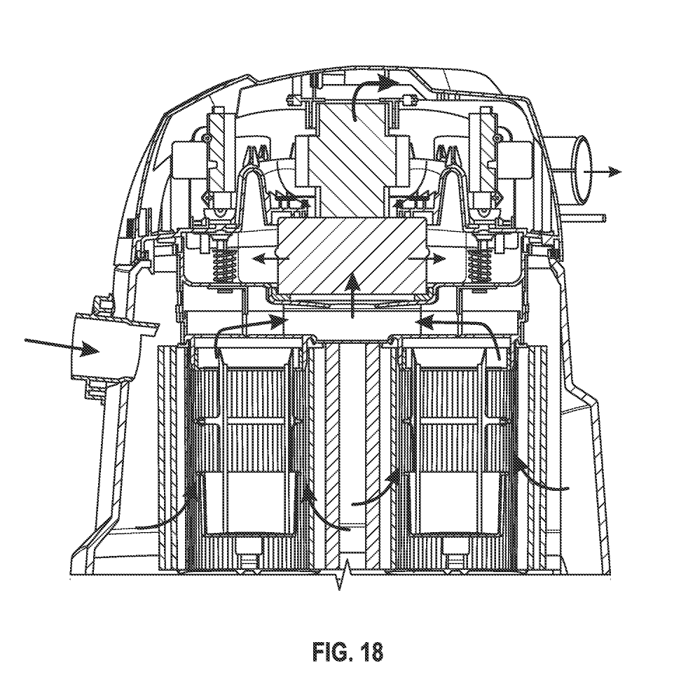

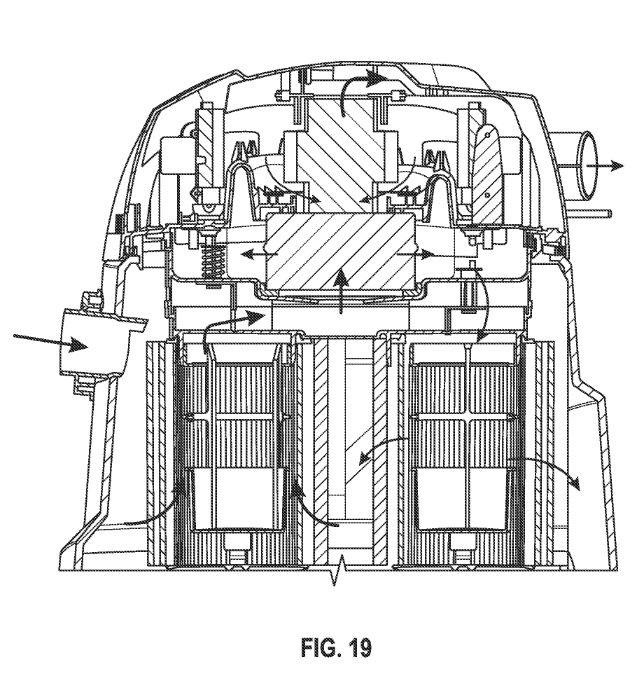

FIG. 17 illustrates a general, cross-sectional view of a self-cleaning filter vacuum appliance 1500. FIG. 18 illustrates the various air-flow pathways of the vacuum appliance 1500 during a typical vacuum operation. FIG. 19 illustrates the air flow within vacuum appliance 1500 during a typical cleaning operation. FIGS. 17-19 will be described in conjunction with each other.

With reference to FIG. 17, vacuum appliance 1500 comprises a collection canister, or drum, 1512 having sides, a bottom, and an open top, similar to the vacuum appliance 10 illustrated in FIG. 1A. Vacuum appliance 1500 also includes a powerhead assembly 1514 releaseably secured to the top of the collection drum 1512 by way of one or more securement mechanisms, such as latches (not shown). A vacuum inlet, or intake, 1528 is formed in the collection drum 1512, preferably in the upper region of the drum, the inlet 1528 allowing for fluid communication between a vacuum hose (not shown) inserted or attached to the inlet 1528 and the powerhead.

Powerhead 1514 includes a vacuum outlet, or exhaust port 1526, formed in the powerhead 1514. In accordance with select aspects of this embodiment, outlet 1526 is oriented approximately 180 degrees from the direction of orientation of the vacuum inlet 1528. Housed within powerhead 1514 is a motor (M) and vacuum impeller assembly 1530, the latter preferably mounted below the motor M and acting to move vacuum air within the vacuum system. Powerhead 1514 further includes two oppositely-spaced motor actuators 1540 associated with, and communication with, valves 1542, the actuators acting to operate valves 1542, which are in turn spring-biased into their various positions. Extending downwardly from the bottom face of the lid 1525 of powerhead 1514 are two oppositely-spaced suction filter assemblies 1550, each filter assembly including at least a filter cage 1552, float 1554, and filter element 1556 similar to those described previously herein.

The cross-sectional view illustrated in FIG. 18 presents exemplary air-flow paths for the vacuum appliance 1500 during vacuum operations, such that the vacuum filters are not obstructed, as measured by a control module. In the figure, the blue arrow shows the flow path of vacuum air into the system; the red arrow shows the fluid flow path to the vacuum air outlet; the green arrows depict the airflow of motor air around the motor; and the orange arrow depicts the flow direction of motor air out during operation of the system. From this Figure, the system of vacuum appliance 1500 includes two (or more) separate air flow paths within the vacuum appliance—one for the motor, and a second, separate flow path for the vacuum air. Each of these paths is further divided into two parts. The motor air is divided into intake/cooling air and exhaust, waste air. The vacuum air is typically divided into an ‘air-in’ (suction side) and ‘air out’ (over pressure side).

FIG. 19 illustrates exemplary air-flow paths for airflow within the vacuum appliance 1500 during system cleaning operations. This mode is typically used when the vacuum filters are obstructed (as determined by the control module), indicating that the filters need to be cleaned. In the figure, the blue arrow shows the flow path of vacuum air into the system; the red arrow shows the fluid flow path to the vacuum air outlet; the green arrows depict the airflow of motor air around the motor; and the orange arrow depicts the flow direction of motor air out during operation of the system. In the cross-sectional image of FIG. 19, it is clear that the filter assembly on the right side is being cleaned by having pressurized air from the vacuum exhaust directly into it. This in turn pushes dirt off the filter from the inside-out. Of note, this clean cycle lasts only a moment, then the control module switches the filter on the left side of FIG. 19 to clean, and the filter on the right, back of the vacuum appliance to the vacuum. Consequently, vacuuming is not interrupted.

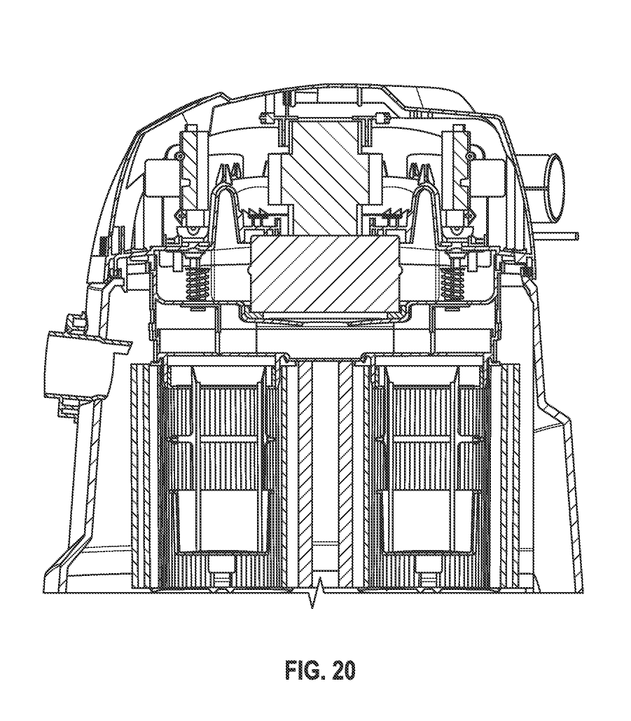

FIG. 20 depicts an example of how the control modules 1560, 1570 of appliance 1500 senses a dirty filter assembly 1550, particularly a dirty filter element 1556, and cleans it. Control module 1560 includes a sensor to monitor pressure inside the vacuum drum, while control module 1570 includes a sensor to monitor pressure inside the drum. During operation, the control module senses pressure at two points—inside the drum, and inside the collector. When the filters 1556 are clean, the two filters are substantially equivalent in value and the control module leaves the unit in vacuum mode. When these pressures are different in value, such as when the filter elements 1556 of filter assembly 1550 are very dirty, the control module automatically switches puts the vacuum appliance in filter cleaning mode. Since there are two filters, this mode doesn't interfere with the vacuum's normal operation, and the cleaning ensures the vacuum optimizes in or at optimal level.

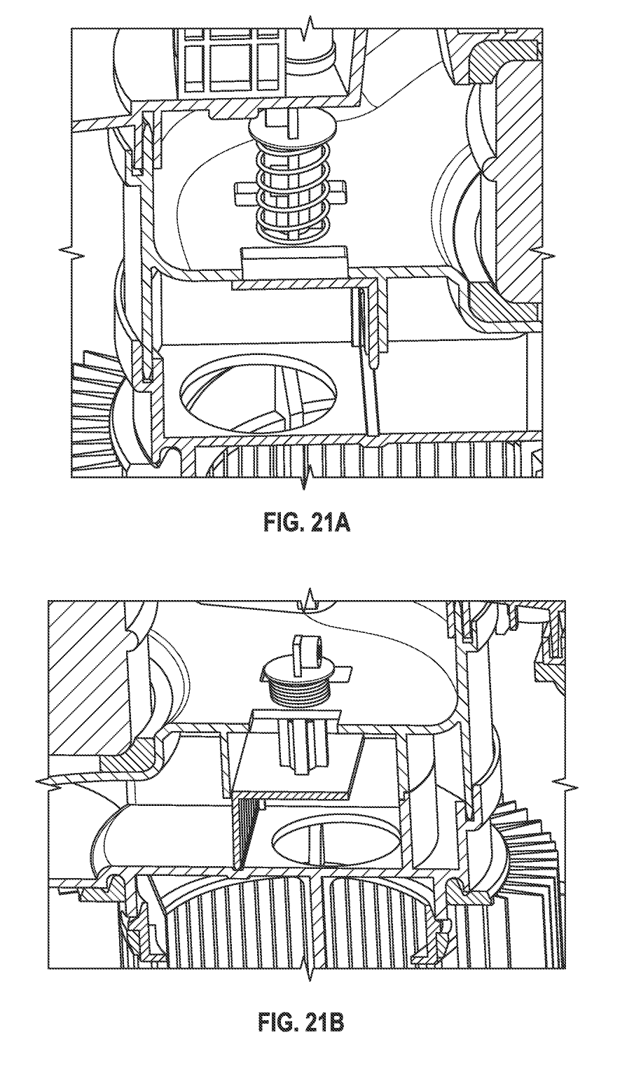

FIG. 21A illustrates the details of valve assembly 1600 and 1600′ from vacuum appliance 1500. These valves are designed to operate in a linear fashion, exactly as the actuators 1540 operates. This minimizes the chances of the valves binding or jamming in operation that other, non-linear designs can. In the normal operation, the spring 1610 holds the valve 1600 closed against positive pressure above and the negative pressure below. This has the benefit of ensuring that even in the event of an actuator failure or controller failure, the vacuum will remain operational. Additionally, since the forces of the air flow opposes the action of the spring 1610, the actuator 1540 only has to overcome the difference in pressures and spring forces, so the actuation force is minimized, thus in turn prolonging actuator life by reducing operating stresses.

FIG. 21B illustrates details of valve assembly 1600′ during the filter cleaning mode, wherein the actuator 1540 pushes the valve downwards, closing the suction path, and opening a positive-pressure path for cleaning of the filters. In non-linear designs, such as when a valve pivots into place, the suction force of the unit holds the valve closed. This means that the return spring 1610′ has to be very strong, which in turn can make it hard for the actuator 1540 to operate. In the design represented by FIG. 21B, the suction force acts perpendicularly to the direction of actuation. This means that in order to close the valve when the actuator 1540 deactivates, the spring 1610′ only has to overcome the friction between the valve and the housing.

While filter system 100 has been described herein with reference to one or more directions of movement for illustrative purposes, one of ordinary skill will understand that this need not be the case and that the components described herein can be arranged in numerous ways. For example, referring again to FIGS. 1-8, while actuator 206 has been described as moving outwardly from drum 12 to open backflush valve 202 and close inlet valve 204, this need not be the case, and actuator 206 may be configured to move inwardly of drum 12 to perform the same functions. As further examples, shoulder sealing region 222 (FIG. 6G) may move inwardly from backflush port 224 and inlet valve 204 may pivot in a direction opposite of that described herein.

Valves 202, 204 may be any type of valves required by a particular application, including being the same type of valve. Valves 202, 204 may be coupled to a single actuator, as described herein, such as to act simultaneously, but need not, and may alternatively be coupled to separate actuators, which may be mechanical, electrical, or a combination thereof, such as being electro-mechanical.

Other and further embodiments utilizing one or more aspects of the invention described above can be devised without departing from the spirit of Applicant's invention. For example, a vacuum cleaner may include a single filter system 100 in combination with one or more conventional filter systems known in the art. Further, the various methods and embodiments of the filter system can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, the Applicant intends to fully protect all such modifications and improvements that come within the scope or range of equivalents of the following claims.

What is claimed is:

1. A backflush filter cleaning system, the system comprising:
a filter cage;
a backflush valve disposed at a first end of the filter;
an intake plenum fluidicly disposed at a second end of the filter;
an inlet valve disposed in an air path between a surface of the filter and an air outlet of the inlet valve.

2. The system of claim 1, wherein the cleaning actuator is adapted to open the backflush valve and close the inlet valve.

3. The system of claim 2, wherein the cleaning actuator is adapted to simultaneously open the backflush valve and close the inlet valve.

4. The system of claim 1, further comprising a biasing device coupled to the cleaning actuator so that the backflush valve is adapted to be biased in a closed position and the inlet valve is adapted to biased in an open position.

5. The system of claim 1, further comprising:
a filter cap,
wherein the filter cap is coupled to the first end of the filter cage so that a surface of the filter cap is in sealing engagement with a backflush port coupled to the first end of the filter cage and so that the cleaning actuator is accessible through an opening in the filter cap.

6. The system of claim 1, further comprising a tubular filter coupled between the backflush valve and the inlet valve, the filter having an inner surface disposed adjacent to the at least one peripheral opening of the filter cage.

7. The system of claim 1, wherein a first airflow path is defined when the backflush valve is closed and the inlet valve is open, the first airflow path being between the at least one peripheral opening of the filter cage and the air outlet of the intake plenum.

8. The system of claim 7, further comprising:
an intake manifold having a first end coupled to the air outlet; and
a vacuum source coupled to a second end of the manifold and adapted to flow air along the first airflow path when energized;
wherein the air flows downward along at least a portion of the first airflow path when the vacuum source is energized.

9. The system of claim 1, wherein a second airflow path is defined between the backflush valve and the at least one peripheral opening of the filter cage when the backflush valve is open and the inlet valve is closed.

10. The system of claim 1, further comprising:
a vacuum airflow path between the at least one peripheral opening and the second end of the filter cage when the inlet valve is in an open position; and
a backflush airflow path between the first end of the filter cage and the at least one peripheral opening when the inlet valve is in a closed position.

11. A vacuum cleaner system, comprising:
a vacuum source;
a collector;
a lid coupled to the collector;
a first backflush filter cleaning system coupled at least partially inside the collector, wherein the first backflush filter cleaning system comprises a first backflush valve, a first intake plenum, a first inlet valve, and a first cleaning actuator; and
an intake manifold having a first end coupled to a first air outlet of the first intake plenum and a second end coupled to the vacuum source,
wherein the first backflush valve is disposed on a first end of the first backflush filter and the first inlet valve is disposed on a second end of the first backflush filter.

12. The vacuum cleaner system of claim 11, further comprising:
a second backflush filter cleaning system coupled at least partially inside the collector, wherein the second backflush filter cleaning system comprises a second filter cage, a second backflush valve, a second intake plenum, a second inlet valve, a second cleaning actuator, and a second air outlet,
further wherein the second air outlet is coupled to the first end of the intake manifold.

13. The vacuum cleaner system of claim 11, further comprising:
a removable filter cap sealingly coupled to an opening in the lid;
wherein a surface of the filter cap is in sealing engagement with a backflush port coupled to the first end of the first filter cage; and
wherein the first cleaning actuator is accessible through the opening in the filter cap.

14. The vacuum cleaner system of claim 11, wherein the first backflush filter cleaning system is coupled to the lid so that the first backflush valve is in fluid communication with an atmosphere surrounding the vacuum cleaner system and so that the first inlet valve is disposed inside the collector.

15. The vacuum cleaner system of claim 11, further comprising a tubular filter disposed vertically inside the collector, the filter having a first end in fluid communication with the first backflush valve, a second end in fluid communication with the first inlet valve, and an inner surface disposed adjacent to the at least one peripheral opening of the first filter cage.

16. A system adapted to clean a filter coupled to a vacuum cleaner, the system comprising:
means for establishing a first airflow path from inside a vacuum cleaner collector;
means for energizing the vacuum source;
means for closing an inlet valve and opening a backflush valve, thereby establishing a second airflow; and
means for flowing air along the second airflow path, thereby cleaning the filter.

17. The system of claim 16, wherein the means for establishing the first airflow path includes a means for biasing the backflush valve in a closed position and a means for biasing the inlet valve in an open position.

18. The system of claim 17, where in the means for biasing the backflush valve and the means for biasing the inlet valve simultaneously cause the backflush valve and the inlet valve to a closed and opened position, respectively.

19. The system of claim 16, wherein the means for closing the inlet valve and opening the backflush valve is controlled by control logic adapted to be stored on a computer readable medium.

20. The system of claim 19, wherein the means for closing the inlet valve and opening the backflush valve is controlled by the control logic based a pressure differential detected by the control logic.

21. A system adapted to clean a filter coupled to a vacuum cleaner, the system comprising:
a backflush valve disposed on a first end of the filter;
an inlet valve disposed on a second end of the filter;
a first airflow path adapted to flow air from an outer surface of the filter to a vacuum cleaner collector; and
a second airflow path adapted to flow air from the inlet valve to an outer surface of the filter.

22. The system of claim 21, further comprising a cleaning actuator, wherein the cleaning actuator is adapted to open and/or close the inlet valve, the backflush valve, or both.

23. The system of claim 22, wherein the cleaning actuator comprises an electronic actuator.

24. The system of claim 23 wherein the movement of the electronic actuator is adapted to be controlled by control logic.

25. The system of claim 21 further comprising a first indicator, wherein the first indicator is adapted to signal that the filter should be either cleaned or replaced.
